(19) United States
(12) Patent Application Publication
(10) Pub. No.: US 2017/0161441 A1
(43) Pub. Date: Jun. 8, 2017

(54) METHODS AND MATERIALS FOR TREATING PAIN AND DEPRESSION

(71) Applicant: RIDGE DIAGNOSTICS, INC., La Jolla, CA (US)

(72) Inventor: John Bilello, Durham, NC (US)

(21) Appl. No.: 15/323,708

(22) PCT Filed: Jul. 2, 2015
(86) PCT No.: PCT/US15/39091

§ 371 Date: Jan. 3, 2017

Related U.S. Application Data
(60) Provisional application No. 62/020,033, filed on Jul. 2, 2014.

(51) Int. Cl. G06F 19/00

(52) U.S. Cl. CPC G06F 19/325; G06F 19/3431

(57) ABSTRACT

Materials and methods for identifying patients with chronic pain comorbid with depression are provided herein. For example, algorithms and/or hypermapping based on a combination of biomarkers can be used to identify patients with chronic pain comorbid with depression.

### CROSS-REFERENCE TO RELATED APPLICATIONS

This application claims benefit of priority from U.S. Provisional Application No. 62/020,033, filed on Jul. 2, 2014.

### TECHNICAL FIELD

This document relates to materials and methods for identifying patients with chronic pain comorbid with depression. For example, this document relates to materials and methods for using algorithms and/or hypermapping based on a combination of parameters to identify patients with chronic pain comorbid with depression.

### BACKGROUND

Pain and depression are highly prevalent conditions encountered by primary care physicians, psychiatrists, and pain specialists. The primary care patient lifetime prevalence of pain symptoms ranges from 24% to 37%, while major depressive disorder (MDD, also referred to a unipolar depression) has a lifetime prevalence in primary care patients of 5% to 10% (Bair et al., Arch Intern Med 163:2433-2445, 2003). Psychiatric illness such as MDD is a common comorbidity in chronic pain patients, often confounding a full diagnosis of those individuals. Many chronic pain patients who develop psychiatric illness following the onset of their pain will subsequently report both greater pain intensity and pain-related disability, and they may experience poorer pain treatment outcomes than those patients with chronic pain alone (Lindsay and Wyckoff, Psychosomatics 22571-22573, 1981; Gallagher and Verma, Semin Clin Neuropsychiatry 4203-4220, 1999; Kroenke et al., J Pain 12:964-973, 2011; and Elman et al., Arch Gen Psych 68:12-20, 2011). Depression also has been associated with suicide attempts and suicide completion among people with chronic pain (Fishbain, Am J Public Health 86:1320-1321, 1996; Cheatle, Pain Med 12(Suppl 2):S42-S48, 2011; and Hooley et al., Curr Pain Headache Reports 18:1-6, 2014).

### SUMMARY

The treatment of pain symptomatology helps some, but not all, chronic pain patients (Turk, Clin J Pain 18:355-365, 2002). One explanation for this finding is that psychological correlates to chronic pain, such as MDD, can interfere with the effectiveness of pain treatment if not addressed. The care for chronic pain patients does not routinely involve the use of depression scales and clinical evaluations. The identification of a physiological pattern reflective of comorbid pain and depression could permit clinicians to positively identify both pain and depression and determine appropriate treatment, and it also could help to decide Workman's Compensation-related matters, for example. As described herein, a convenient and accurate quantitative test can be used as a depression diagnostic tool in chronic pain patients. In particular, the MDDSCORE™ (see, e.g., Papakostas et al., Mol Psych 18:332-339, 2013) involves the use of a biomarker panel to aid in MDD diagnosis. The panel includes biomarkers associated with the neurotrophic, metabolic, inflammatory and hypothalamic-pituitary-adrenal (HPA) axis pathways. This panel, plus its associated algorithm, exhibits high sensitivity and specificity in differentiating MDD patients from normal subjects. The present document provides for the use of multi-analyte biomarker panels and algorithms to aid clinicians in the diagnosis of depression in patients with chronic pain.

In one aspect, this document features a method for treating depression in a subject diagnosed as having centralized intractable pain (CIP). The method can include (a) performing a quantitative assay to measure the level of each of at least three biomarkers in a biological sample from the subject, to obtain a numerical value corresponding to the measured level of each biomarker, wherein the at least three biomarkers are selected from the group consisting of cortisol, prolactin (PRL), epidermal growth factor (EGF), myeloperoxidase (MPO), brain-derived neurotrophic factor (BDNF), resistin (RETN), soluble tumor necrosis factor alpha receptor type 2 (sTNFR2), apolipoprotein CIII (ApoC3; also referred to as ApoCIII), and alpha 1 antitrypsin (A1AT); (b) calculating a depression diagnostic score using an algorithm that weights each numerical value; (c) comparing the calculated depression diagnostic score to a control score calculated using the algorithm and numerical values corresponding to measured levels of the at least three biomarkers in normal subjects; (d) diagnosing the subject as having depression when the difference between the diagnostic depression score and the control score is greater than a predetermined threshold; and (e) treating the subject for depression.

The method can include performing the quantitative assay to measure the level of each of at least five biomarkers in the biological sample, to obtain a numerical value corresponding to the measured level of each biomarker, wherein the at least five biomarkers are selected from the group consisting of cortisol, PRL, EGF, MPO, BDNF, RETN, sTNFR2, ApoC3, and A1AT, or performing the quantitative assay to measure the level of each of at least seven biomarkers in the biological sample, to obtain a numerical value corresponding to the measured level of each biomarker, wherein the at least seven biomarkers are selected from the group consisting of cortisol, PRL, EGF, MPO, BDNF, RETN, sTNFR2, ApoC3, and A1AT. The at least three biomarkers can include cortisol, PRL, EGF, MPO, BDNF, RETN, sTNFR2, ApoC3, and A1AT. The biomarkers can further include body mass index (BMI). The biological sample can be a blood (e.g., serum) or urine sample. The quantitative assay can be an immunological assay. The comparing step can include using a hypermap to assess the difference between the diagnostic depression score and the control score. The method can further include performing a quantitative assay to measure the level of an opioid compound in a second biological sample from the subject. The second biological sample can be a blood or urine sample.

In another aspect, this document features a method for treating CIP that includes (a) performing a quantitative assay to measure the level of each of three or more biomarkers in a biological sample from a subject suspected to have CIP, to obtain a numerical value corresponding to the measured level of each biomarker, wherein the three or more biomarkers are selected from the group consisting of cortisol, PRL, EGF, MPO, BDNF, RETN, sTNFR2, ApoC3, and A1AT; (b) calculating a CIP diagnostic score using an algorithm that weights each numerical value; (c) comparing the calculated CIP diagnostic score to a control score calculated using the algorithm and numerical values corresponding to measured levels of the at least three biomarkers in normal subjects; (d) diagnosing the subject as having CIP when the difference between the CIP diagnostic score and the control score is greater than a predetermined threshold; and (e) treating the subject for CIP.

The method can include performing the quantitative assay to measure the level of each of at least five biomarkers in the biological sample, to obtain a numerical value corresponding to the measured level of each biomarker, wherein the at least five biomarkers are selected from the group consisting of cortisol, PRL, EGF, MPO, BDNF, RETN, sTNFR2, ApoC3, and A1AT, or performing the quantitative assay to measure the level of each of at least seven biomarkers in the biological sample, to obtain a numerical value corresponding to the measured level of each biomarker, wherein the at least seven biomarkers are selected from the group consisting of cortisol, PRL, EGF, MPO, BDNF, RETN, sTNFR2, ApoC3, and A1AT. The at least three biomarkers can include cortisol, PRL, EGF, MPO, BDNF, RETN, sTNFR2, ApoC3, and A1AT. The biomarkers can further include BMI. The biological sample can be a blood (e.g., serum) or urine sample. The quantitative assay can be an immunological assay. The comparing step can include using a hypermap to assess the difference between the CIP diagnostic score and the control score. The method can further include performing a quantitative assay to measure the level of an opioid compound in a second biological sample from the subject. The second biological sample can be a blood or urine sample.

In another aspect, this document features a method for treating pain and depression. The method can include (a) identifying a subject being treated for pain; (b) testing the subject for depression; (c) if the subject is identified as having depression, treating the depression, or if the subject is identified as not having depression, repeating step (b) after a period of time; and (d) maintaining the treatment for pain. Step (b) can include (i) performing a quantitative assay to measure the level of each of at least three biomarkers in a biological sample from the subject, to obtain a numerical value corresponding to the measured level of each biomarker, wherein the at least three biomarkers are selected from the group consisting of cortisol, PRL, EGF, MPO, BDNF, RETN, sTNFR2, ApoC3, and A1AT, (ii) calculating a depression diagnostic score using an algorithm that weights each numerical value; (iii) comparing the calculated depression diagnostic score to a control score calculated using the algorithm and numerical values corresponding to measured levels of the at least three biomarkers in normal subjects; and (iv) identifying the subject as having depression when the difference between the diagnostic depression score and the control score is greater than a predetermined threshold.

The method can include performing the quantitative assay to measure the level of each of at least five biomarkers in the biological sample, to obtain a numerical value corresponding to the measured level of each biomarker, wherein the at least five biomarkers are selected from the group consisting of cortisol, PRL, EGF, MPO, BDNF, RETN, sTNFR2, ApoC3, and A1AT, or performing the quantitative assay to measure the level of each of at least seven biomarkers in the biological sample, to obtain a numerical value corresponding to the measured level of each biomarker, wherein the at least seven biomarkers are selected from the group consisting of cortisol, PRL, EGF, MPO, BDNF, RETN, sTNFR2, ApoC3, and A1AT. The at least three biomarkers can include cortisol, PRL, EGF, MPO, BDNF, RETN, sTNFR2, ApoC3, and A1AT. The biomarkers further can further include BMI. The biological sample can be a blood (e.g., serum) or urine sample. The quantitative assay can be an immunological assay. The comparing step can include using a hypermap to assess the difference between the depression diagnostic score and the control score. The period of time can be at least one month.

In still another aspect, this document features a method for monitoring a pain patient for depression. The method can include (a) identifying a patient diagnosed as having pain; (b) obtaining a biological sample from the patient at least once every three months over the course of at least six months; (c) analyzing the biological samples to determine whether the patient has depression; and (d) if the patient is determined to have depression, treating the depression. Step (c) can include (i) performing a quantitative assay to measure the level of each of at least three biomarkers in a biological sample from the patient, to obtain a numerical value corresponding to the measured level of each biomarker, wherein the at least three biomarkers are selected from the group consisting of cortisol, PRL, EGF, MPO, BDNF, RETN, sTNFR2, ApoC3, and A1AT; (ii) calculating a depression diagnostic score using an algorithm that weights each numerical value; (iii) comparing the calculated depression diagnostic score to a control score calculated using the algorithm and numerical values corresponding to measured levels of the at least three biomarkers in normal subjects; and (iv) determining that the patient has depression when the difference between the diagnostic depression score and the control score is greater than a predetermined threshold.

The method can include performing the quantitative assay to measure the level of each of at least five biomarkers in the biological sample, to obtain a numerical value corresponding to the measured level of each biomarker, wherein the at least five biomarkers are selected from the group consisting of cortisol, PRL, EGF, MPO, BDNF, RETN, sTNFR2, ApoC3, and A1AT, or performing the quantitative assay to measure the level of each of at least seven biomarkers in the biological sample, to obtain a numerical value corresponding to the measured level of each biomarker, wherein the at least seven biomarkers are selected from the group consisting of cortisol, PRL, EGF, MPO, BDNF, RETN, sTNFR2, ApoC3, and A1AT. The at least three biomarkers can include cortisol, PRL, EGF, MPO, BDNF, RETN, sTNFR2, ApoC3, and A1AT. The biomarkers can further include BMI. The biological sample can be a blood (e.g., serum) or urine sample. The quantitative assay can be an immunological assay. The comparing step can include using a hypermap to assess the difference between the depression diagnostic score and the control score.

This document also features an ex vivo method for monitoring a pain patient for depression. The method can include analyzing biological samples from a patient to determine whether the patient has depression, wherein the patient was diagnosed as having pain, and wherein the biological samples were obtained from the patient at least once every three months over the course of at least six months. The analyzing can include (i) performing a quantitative assay to measure the level of each of at least three biomarkers in a biological sample from the patient, to obtain a numerical value corresponding to the measured level of each biomarker, wherein the at least three biomarkers are selected from the group consisting of cortisol, PRL, EGF, MPO, BDNF, RETN, sTNFR2, ApoC3, and A1AT; (ii) calculating a depression diagnostic score using an algorithm that weights each numerical value; (iii) comparing the calculated depression diagnostic score to a control score calculated using the algorithm and numerical values corresponding to measured levels of the at least three biomarkers in normal subjects; and (iv) determining that the patient has depression when the difference between the diagnostic depression score and the control score is greater than a predetermined threshold.

The method can include performing the quantitative assay to measure the level of each of at least five biomarkers in the biological sample, to obtain a numerical value corresponding to the measured level of each biomarker, wherein the at least five biomarkers are selected from the group consisting of cortisol, PRL, EGF, MPO, BDNF, RETN, sTNFR2, ApoC3, and A1AT, or performing the quantitative assay to measure the level of each of at least seven biomarkers in the biological sample, to obtain a numerical value corresponding to the measured level of each biomarker, wherein the at least seven biomarkers are selected from the group consisting of cortisol, PRL, EGF, MPO, BDNF, RETN, sTNFR2, ApoC3, and A1AT. The at least three biomarkers can include cortisol, PRL, EGF, MPO, BDNF, RETN, sTNFR2, ApoC3, and A1AT. The biomarkers can further include BMI. The biological sample can be a blood (e.g., serum) or urine sample. The quantitative assay can be an immunological assay. The comparing step can include using a hypermap to assess the difference between the depression diagnostic score and the control score.

In yet another aspect, this document features a method for treating pain and depression that includes (a) identifying a subject with CIP; (b) administering pain medication to the subject; (c) testing the subject for depression; and (d) if the subject is determined to have depression, treating the depression, or if the subject is determined not to have depression, repeating step (c) after a period of time. Step (c) can include (i) performing a quantitative assay to measure the level of each of at least three biomarkers in a biological sample from the patient, to obtain a numerical value corresponding to the measured level of each biomarker, wherein the at least three biomarkers are selected from the group consisting of cortisol, PRL, EGF, MPO, BDNF, RETN, sTNFR2, ApoC3, and A1AT; (ii) calculating a depression diagnostic score using an algorithm that weights each numerical value; (iii) comparing the calculated depression diagnostic score to a control score calculated using the algorithm and numerical values corresponding to measured levels of the at least three biomarkers in normal subjects; and (iv) determining that the patient has depression when the difference between the diagnostic depression score and the control score is greater than a predetermined threshold.

The method can include performing the quantitative assay to measure the level of each of at least five biomarkers in the biological sample, to obtain a numerical value corresponding to the measured level of each biomarker, wherein the at least five biomarkers are selected from the group consisting of cortisol, PRL, EGF, MPO, BDNF, RETN, sTNFR2, ApoC3, and A1AT, or performing the quantitative assay to measure the level of each of at least seven biomarkers in the biological sample, to obtain a numerical value corresponding to the measured level of each biomarker, wherein the at least seven biomarkers are selected from the group consisting of cortisol, PRL, EGF, MPO, BDNF, RETN, sTNFR2, ApoC3, and A1AT. The at least three biomarkers can include cortisol, PRL, EGF, MPO, BDNF, RETN, sTNFR2, ApoC3, and A1AT. The biomarkers can further include BMI. The biological sample can be a blood (e.g., serum) or urine sample. The quantitative assay can be an immunological assay. The comparing step can include using a hypermap to assess the difference between the depression diagnostic score and the control score. The period of time can be one to six months.

This document also features an ex vivo method for monitoring a pain patient for depression. The method can include analyzing biological samples from a patient to determine whether the patient has depression, wherein the patient was diagnosed as having pain, and wherein the biological samples were obtained from the patient at least once every three months over the course of at least six months. The analyzing can include (i) performing a quantitative assay to measure the level of each of at least three biomarkers in a biological sample from the patient, to obtain a numerical value corresponding to the measured level of each biomarker, wherein the at least three biomarkers are selected from the group consisting of cortisol, PRL, EGF, MPO, BDNF, RETN, sTNFR2, ApoC3, and A1AT; (ii) calculating a depression diagnostic score using an algorithm that weights each numerical value; (iii) comparing the calculated depression diagnostic score to a control score calculated using the algorithm and numerical values corresponding to measured levels of the at least three biomarkers in normal subjects; and (iv) determining that the patient has depression when the difference between the diagnostic depression score and the control score is greater than a predetermined threshold.

The method can include performing the quantitative assay to measure the level of each of at least five biomarkers in the biological sample, to obtain a numerical value corresponding to the measured level of each biomarker, wherein the at least five biomarkers are selected from the group consisting of cortisol, PRL, EGF, MPO, BDNF, RETN, sTNFR2, ApoC3, and A1AT, or performing the quantitative assay to measure the level of each of at least seven biomarkers in the biological sample, to obtain a numerical value corresponding to the measured level of each biomarker, wherein the at least seven biomarkers are selected from the group consisting of cortisol, PRL, EGF, MPO, BDNF, RETN, sTNFR2, ApoC3, and A1AT. The at least three biomarkers can include cortisol, PRL, EGF, MPO, BDNF, RETN, sTNFR2, ApoC3, and A1AT. The biomarkers can further include BMI. The biological sample can be a blood (e.g., serum) or urine sample. The quantitative assay can be an immunological assay. The comparing step can include using a hypermap to assess the difference between the depression diagnostic score and the control score.

In yet another aspect, this document features an apparatus for characterizing depression in a pain patient. The apparatus can include any or all of the following: (i) means for performing a quantitative assay to measure the level of each of at least three biomarkers in a biological sample from the patient, to obtain a numerical value corresponding to the measured level of each biomarker; (ii) means for calculating a depression diagnostic score using an algorithm that weights each numerical value; (iii) means for comparing the calculated depression diagnostic score to a control score calculated using the algorithm and numerical values corresponding to measured levels of the at least three biomarkers in normal subjects; and (iv) means for classifying the patient as having depression when the difference between the diagnostic depression score and the control score is greater than a predetermined threshold, or a combination of any of parts (i) to (iv).

The at least three biomarkers can be selected from the group consisting of cortisol, PRL, EGF, MPO, BDNF, RETN, sTNFR2, ApoC3, and A1AT. The apparatus can include means for performing the quantitative assay to measure the level of each of at least five biomarkers in the biological sample, to obtain a numerical value corresponding to the measured level of each biomarker, wherein the at least five biomarkers are selected from the group consisting of cortisol, PRL, EGF, MPO, BDNF, RETN, sTNFR2, ApoC3, and A1AT, or means for performing the quantitative assay to measure the level of each of at least seven biomarkers in the biological sample, to obtain a numerical value corresponding to the measured level of each biomarker, wherein the at least seven biomarkers are selected from the group consisting of cortisol, PRL, EGF, MPO, BDNF, RETN, sTNFR2, ApoC3, and A1AT. The at least three biomarkers can include cortisol, PRL, EGF, MPO, BDNF, RETN, sTNFR2, ApoC3, and A1AT. The biomarkers can further include BMI. The biological sample can be a blood (e.g., serum) or urine sample. The quantitative assay can be an immunological assay. The means for comparing can include a means for using hypermap to assess the difference between the depression diagnostic score and the control score.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a flow diagram showing steps that can be taken to establish a set of pharmacodynamic biomarkers that indicate a positive or negative response to treatment by use of biomarker measurements.

FIG. 2 is a flow diagram showing the steps in an exemplary method for developing a disease specific library or panel with an algorithm for diagnostic development.

FIG. 3 is a flow diagram showing steps in a method for developing a basic diagnostic score, where n diagnostic scores are generated. Diagnostic score Sn=Fn(C1, . . . Cn, M1, . . . Mn), where Sn is the nth score and Fn is the nth function, and Cn and Mn are the nth coefficient and nth marker expression level, respectively.

FIG. 4 is a flow diagram outlining steps in a method for using blood to diagnose, select treatment, monitor treatment efficacy, and optimize therapy. Diagnostic score Sn=Fn(C1, . . . Cn, M1, . . . Mn), where Sn is the nth score and Fn is the nth function, and Cn and Mn are the nth coefficient and nth marker expression level, respectively.

FIG. 5 is a diagram depicting steps that can be included in some embodiments of a method for generating a hypermap for particular disease.

FIG. 6 is a diagram depicting steps that can be included in some embodiments of a process for constructing a hypermap from selected groups of markers and clinical data for a particular disease.

FIG. 7 shows an example of a computer-based diagnostic system employing the biomarker analysis described in this document.

FIG. 8 shows an example of a computer system that can be used in the system in FIG. 7.

FIG. 9 is a graph plotting pathway values for the inflammatory, neurotropic, HPA axis, and metabolic pathways in CIP patients having an MDDSCORE™ greater than or equal to five (solid bars) or less than five (open bars), where the pathway values are based on median serum levels of biomarkers in the four pathways.

FIG. 10 is a graph plotting MDDSCORE™ and levels of thyroid-stimulating hormone (TSH) in CIP patients.

FIGS. 11A and 11B are a pair of hypermaps. Vectors were generated for HPA axis, neurotropic, and inflammatory marker levels (FIG. 11A), or HPA axis, metabolic, and inflammatory marker levels, in normal subjects and in CIP patients having an MDDSCORE™ greater than or equal to or less than 5.

FIG. 12 is a hypermap generated for a CIP patient (“patient E”) before and after seven months of treatment, showing vectors generated using HPA axis, neurotropic, and inflammatory markers. The MDDSCORE™ for this patient dropped from 9 to 1 after treatment. In addition, the patient had 5.9-fold decrease in measured levels of HPA markers, and a 1.7-fold decrease in measured levels of inflammation markers.

FIGS. 13A-13L are a series of hypermaps generated for 12 additional CIP patients before and after seven months of treatment, showing vectors generated using HPA axis, neurotropic, and inflammatory markers. FIG. 13A, patient A; FIG. 13B, patient C; FIG. 13C, patient D; FIG. 13D, patient F; FIG. 13E, patient G; FIG. 13F patient H; FIG. 13G, patient I; FIG. 13H, patient J; FIG. 13I, patient K; FIG. 13J, patient L; FIG. 13K, patient M; FIG. 13L, patient N.

FIG. 14 is a graph plotting MDDSCORE™ for 14 CIP patients before and after seven months of treatment.

FIGS. 15A-15M are a series of graphs plotting serum levels of cortisol, BDNF, EGF, MPO, PRL, RETN, A1AT, sTNFR2, and ApoC3, as well as body mass index (BMI) in 13 CIP patients before (circles) and after (triangles) seven months of treatment. FIG. 15A, patient A; FIG. 15B, patient B; FIG. 15C, patient C; FIG. 15D, patient D; FIG. 15E, patient E; FIG. 15F patient F; FIG. 15G, patient G; FIG. 15H, patient H; FIG. 15I, patient I; FIG. 15J, patient K; FIG. 15K, patient L; FIG. 15L, patient M; FIG. 15M, patient N.

FIG. 16 is a graph plotting MDDSCORE™ in normal subjects (black bars) and CIP patients (gray bars).

FIGS. 17A-17J are a series of graphs plotting serum levels of A1AT (FIG. 17A), MPO (FIG. 17B), sTNFR2 (FIG. 17C), BDNF (FIG. 17D), cortisol (FIGS. 17E and 17F), EGF (FIG. 17G), PRL (FIG. 17H), RETN (FIG. 17I), and ApoCIII (FIG. 17J) in CIP patients and in normal subjects. Mean and standard deviation are indicated for each group in each graph.

FIG. 18 is a graph plotting MDDSCORE™ for a series of 94 CIP patients. A group of nine biomarkers was used in a combination algorithm to calculate the MDDSCORE™ for each patient. The histogram indicates a bimodal distribution, with approximately half of the CIP patients having MDDSCORE™>5. Sensitivity and specificity of the test from previous studies were 94% and 92% respectively.

FIGS. 19A and 19B are a pair of hypermaps for CIP patient populations. Using clusters of biomarkers reflective of different physiologic parameters (e.g., HPA axis vs. metabolic vs. inflammatory markers), the patient's biomarker responses were mapped onto a three-dimensional hyperspace. Visual inspection of the hypermap display can reveal distinctions between individual patients. FIG. 19A is a hypermap for patients using the metabolic pathway vector as the y-axis. FIG. 19B is a hypermap for the same patients with the neurotrophin pathway vector as the y-axis.

FIG. 20 is a graph plotting a Pathway Vector Map. Biomarker data were obtained for each patient, and the values for biomarkers within each pathway were averaged for the MDDSCORE™<5 and ≧5 populations of CIP patients. Defined and validated coefficients were used to create the hyperspace vector values for each of the four pathways. The CIP patients' pathway vectors were compared to a series of healthy subjects (n=86) without chronic pain.

FIG. 21 is a graph plotting MDDSCORE™ in three groups of pain patients, having CIP, chronic pain of diverse origin (SPC), or arthritis, as indicated. Test scores ranged from 1 to 9. An MDDSCORE™ of 1 to 4 suggests a low probability or likelihood of depression, while an MDDSCORE™ of 5 to 9 suggests a high probability or likelihood of MDD (Bilello et al., J Clin Psych 76(2):e199-206, 2015).

### DETAILED DESCRIPTION

Chronic pain typically is defined as pain that has lasted longer than three to six months, although some have placed the transition from acute to chronic pain at 12 months. Either way, chronic pain is a significant clinical problem that has few effective therapies. The success rate for treating chronic pain with analgesics is about 30%. Both treatment and research into chronic pain are compromised by the fact that there is no objective diagnostic test to complement the subjective assessment of chronic pain conditions.

Centralized intractable pain (CIP) is a subtype of chronic pain. CIP is a severe, constant pain that is not well treated with known methods, and can cause a bed- or house-bound state or even early death in some cases. CIP patients may report suicidal thoughts (e.g., for the sole purpose of stopping the pain), as well as incessant crying spells, fatigue, and depression. CIP also can cause adverse biologic effects on the cardiovascular, hormone, and neurologic systems.

Most pain assessment tools are biased toward evaluating how a patient feels about his or her life. Given the symptom of constant pain, however, in combination with other symptoms such as not sleeping well, it seems that “depression” in CIP patients may have as much to do with being in pain as with being depressed per se.

For depression and many other neuropsychiatric diseases, the primary means of diagnosis is clinical evaluation. As such, physicians often fail to diagnose depression in chronic pain populations (Klein and Wender, Understanding depression: A complete guide to its diagnosis and treatment, Oxford University Press, New York, N.Y., 1993; Nielsen and Williams, Arch Gen Psych 37(9):999-1004, 1980; Howe and Sullivan, Gen Hosp Psych 36:99-104, 2014; and Lopez et al., Psychological Services 10:257-263, 2013). Assessment can be difficult, because depression frequently masquerades as other complaints, including backache, headache, sleep disturbance, and fatigue, all of which are commonly attributed by patients to their pain, and because these patients tend to minimize or deny the cognitive and affective symptoms of depression (Blumer and Heilbronn, J Nerv Ment Dis 170:381-406, 1982; Katon et al., Am J Med 72(1):127-135, 1982; Katon et al., Ann Internal Med 134:917-925, 2001; Lin et al., J Affective Disorders 166:173-178, 2014; and Lopez and Reddy, “Pain Assessment and Management,” Oxford American Handbook of Hospice and Palliative Medicine, Ed. Bruera and Yennurajalingam, Oxford University Press, Inc., New York, N.Y., pp. 31-71, 2011).

The methods described herein can aid clinicians in identifying chronic pain patients with depression (e.g., unipolar depression), providing an early option for antidepressant therapy or other forms of managing such comorbid patients. These methods are based in part on the identification of methods for establishing a diagnosis of depression disorder conditions in CIP patients, as well as methods for monitoring treatment of subjects diagnosed with and treated for comorbid CIP and depression. The methods provided herein can include evaluating (e.g., measuring) multiple parameters and, in some cases, using an algorithm to determine quantitative diagnostic scores. Algorithms for application of multiple biomarkers from biological samples such as serum or plasma can be applied to patient stratification, and also can be used for identification of pharmacodynamic markers.

As used herein, a “biomarker” or “parameter” is a characteristic that can be objectively measured and evaluated as an indicator of a biologic or pathogenic process or a pharmacological response to therapeutic intervention. Biomarkers can be, for example, proteins, nucleic acids, metabolites, physical measurements, or combinations thereof. A “pharmacodynamic” biomarker is a biomarker that can be used to quantitatively evaluate (e.g., measure) the impact of treatment or therapeutic intervention on the course, severity, status, symptomology, or resolution of a disease. As used herein, an “analyte” is a substance or chemical constituent that can be objectively measured and determined in an analytical procedure such as immunoassay or mass spectrometry. An analyte thus can be a type of biomarker or parameter.

Algorithms for determining diagnosis, prognosis, status, or response to treatment, for example, can be determined for particular clinical conditions. The algorithms used in the methods provided herein can be mathematic functions incorporating multiple parameters that can be quantified using, without limitation, medical devices, clinical evaluation scores, or biological/chemical/physical tests of biological samples. Each mathematic function can be a weight-adjusted expression of the levels (e.g., measured levels) of parameters determined to be relevant to a selected clinical condition. Because of the techniques involved in weighting and assessing multiple marker panels, computers with reasonable computational power can be used to analyze the data. Algorithms generally can be expressed in the format of Formula 1:

Diagnostic score=f(x1,x2,x3,x4,x5 . . . xn) (1)

A diagnostic score is a value that is the diagnostic or prognostic result, “f” is any mathematical function, “n” is any integer (e.g., an integer from 1 to 10,000), and x1, x2, x3, x4, x5 . . . xn are the “n” parameters that are, for example, measurements determined by medical devices, clinical evaluation scores, and/or tests results for biological samples (e.g., blood, serum, plasma, urine, or cerebrospinal fluid).

The parameters of an algorithm can be individually weighted. An example of such an algorithm is expressed in Formula 2:

Diagnostic score=f(a1*x1+a2*x2−a3*x3+a4*x4−a5*x5) (2)

Here, x1, x2, x3, x4, and x5 can be measurements determined by medical devices, clinical evaluation scores, and/or test results for biological samples, and a1, a2, a3, a4, and a5 can be weight-adjusted factors for x1, x2, x3, x4, and x5, respectively.

A diagnostic score can be used to quantitatively define a medical condition or disease, or the effect of a medical treatment. For example, an algorithm can be used to determine a diagnostic score for a disorder such as depression or CIP. In one such embodiment, the degree of depression can be defined based on Formula 3, with the following general formula:

Depression diagnosis score=f(x1,x2,x3,x4,x5 . . . xn) (3)

The depression diagnosis score is a quantitative number that can be used to measure the status or severity of depression in an individual, “f” is any mathematical function, “n” can be any integer (e.g., an integer from 1 to 10,000), and x1, x2, x3, x4, x5 . . . xn are, for example, the “n” parameters that are measurements determined using medical devices, clinical evaluation scores, and/or test results for biological samples (e.g., human biological samples).

In a more general format, multiple diagnostic scores Sm can be generated by applying multiple formulas to a group of biomarker measurements, as illustrated in Formula (4)

Scores Sm=fm(x1, . . . xn) (4)

Multiple scores can be useful, for example, in the identification of specific types of disorders (e.g., depression disorders and/or associated disorders, such as sub-types of MDD and/or related or unrelated disorders). Some multiple scores also can be parameters indicating patient treatment progress and/or the utility of the treatment selected. For depression disorders in CIP patients, a treatment progress score can help a health care professional (e.g., a doctor or other clinician) adjust treatment doses and duration. A sub-indication score also can help a health care professional to select optimal drugs or combinations of drugs to use for treatment. By way of example, it has been shown that a link exists between depressed mood and hypothyroidism, and it has been estimated that more than a third of people suffering from depression are hypothyroid. A biomarker panel including elements whose measurements may be indicative of hypothyroid function (e.g., anti-thyroid antibodies, T3, T4, TSH) can be used to calculate a score indicative of hypothyroidism. Combining these data with one or more panels indicative of MDD can allow a clinician to choose a regimen for treating both MDD and hypothyroidism. Cumulative experience based upon measurements with multiple biomarker panels and the success of treatment regimens can provide additional insight into the choice of a regimen.

To determine which parameters are useful for inclusion in a diagnostic method or algorithm, a biomarker library of analytes can be developed, and individual analytes from the library can be evaluated for a particular clinical condition. In the initial phases of biomarker library development, the focus can be on broadly relevant clinical content, such as analytes indicative of inflammation, Th1 and Th2 immune responses, adhesion factors, and proteins involved in tissue remodeling (e.g., matrix metalloproteinases (MMPs) and tissue inhibitors of matrix metalloproteinases (TIMPs)). In some embodiments (e.g., during initial library development), a library can include a dozen or more markers, a hundred markers, or several hundred markers. For example, a biomarker library can include a few hundred protein analytes. As a biomarker library is built, new markers can be added (e.g., markers specific to individual disease states, and/or markers that are more generalized, such as growth factors). In some embodiments, analytes can be added to expand the library and to increase specificity beyond the inflammation, oncology, and neuropsychological foci by addition of disease related proteins obtained from discovery research (e.g., using differential display techniques, such as isotope coded affinity tags (ICAT), mass spectroscopy, accurate mass, and time tags). Matrix-assisted laser desorption and ionization (MALDI) and surface enhanced laser desorption/ionization (SELDI) mass spectrometry can provide high-resolution measurements useful for protein biomarker identification and quantification.

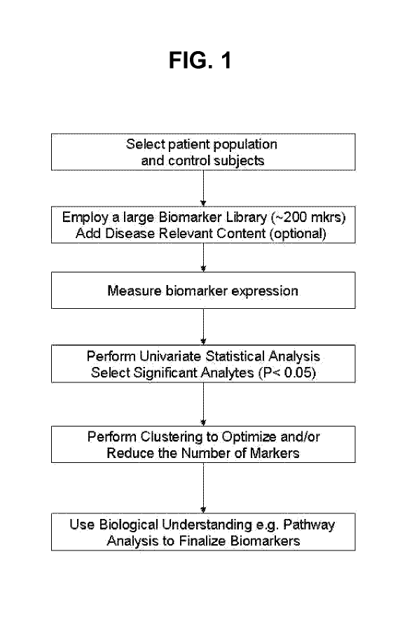

FIG. 1 is a flow diagram detailing the first steps that can be included in development of a disease specific library or panel for use in determining, e.g., diagnosis or prognosis. The process can include two statistical approaches: 1) testing the distribution of biomarkers for association with the disease by univariate analysis; and 2) clustering the biomarkers into groups using a tool that divides the biomarkers into non-overlapping, uni-dimensional clusters, a process similar to principal component analysis. After the initial analysis, a subset of two or more biomarkers from each of the clusters can be identified to design a panel for further analyses. The selection typically is based on the statistical strength of the markers and current biological understanding of the disease.

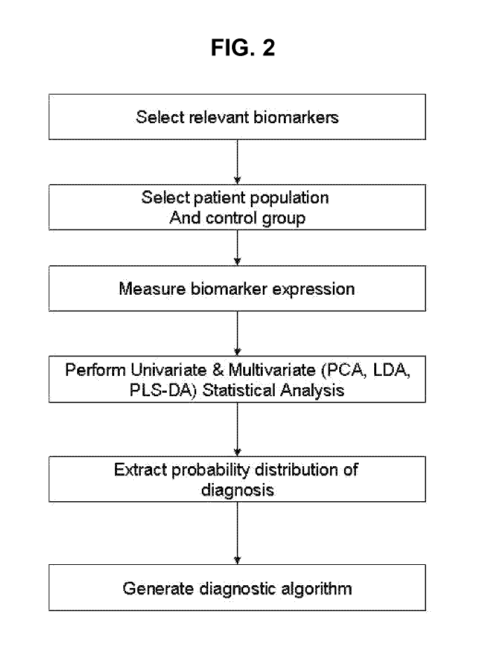

FIG. 2 is a flow diagram depicting steps that can be included to develop a disease specific library or panel for use in establishing diagnosis or prognosis, for example. As shown in FIG. 2, the selection of relevant biomarkers need not be dependent upon the selection process described in FIG. 1, although the first process is efficient and can provide an experimentally and statistically based selection of markers. The process can be initiated, however, by a group of biomarkers selected entirely on the basis of hypothesis and currently available data. The selection of a relevant patient population and appropriately matched (e.g., for age, sex, race, BMI, and/or any other suitable parameters) population of normal subjects typically is involved in the process. In some embodiments, patient diagnoses can be made using state of the art methodology and, in some cases, by a single group of physicians with relevant experience with the patient population. Biomarker expression levels can be measured using Luminex MAP-x, Pierce SEARCHLIGHT, the PHB MIMS instrument or any other suitable technology, including single assays (e.g., ELISA or PCR). Univariate and multivariate analyses can be performed using conventional statistical tools (including, without limitation, T-tests, principal components analysis (PCA), linear discriminant analysis (LDA), linear regression analysis, or binary logistic regression).

The addition of a new analyte to a biomarker library can require a purified or recombinant molecule, as well as the appropriate antibody (or antibodies) to capture and detect the new analyte. It is noted that while application of a biomarker library to conventional ELISA platforms can require multiple antibodies for each analyte, a Molecular Interaction Measurement System (MIMS) developed by Ridge Diagnostics, Inc. (Research Triangle Park, N.C.; formerly Precision Human Biolaboratories, Inc.) can be operated to use a single specific antibody for each analyte. Addition of a new nucleic acid-based analyte to a biomarker library can require the identification of a specific mRNA, as well as probes and detection systems to quantify the expression of that specific RNA. Although discovery of individual “new or novel” biomarkers is not necessary for developing useful algorithms, such markers can be included. Platform technologies that are suitable for multiple analyte detection methods as described herein typically are flexible and open to addition of new analytes. For example, the MIMS platform and other technologies that are suitable for multiple analyte detection methods typically are flexible and open to addition of new analytes. The MIMS platform is a label-free system based on optical sensing. Certain features of the MIMS platform are described in PCT Publication No. WO 2007/067819, which is incorporated herein by reference in its entirety.

While multiplexed detection systems can provide robust and reliable measurement of analytes relevant to diagnosing, treating, and monitoring clinical conditions, this does not preclude the use of assays capable of measuring the concentration of individual analytes from the panel (e.g., a series of single analyte ELISAs). The biomarker panels can be expanded and transferred to traditional protein arrays, multiplexed bead platforms or label-free arrays, and algorithms (e.g., computer-based algorithms) can be developed to support clinicians and clinical research.

Custom antibody array(s) can be designed, developed, and analytically validated for about 25-50 antigens. Initially, a panel of about 5 to 10 (e.g., 5, 6, 7, 8, 9, or 10) analytes can be chosen based on their ability to, for example, distinguish affected from unaffected subjects, or to distinguish between stages of disease in patients from a defined sample set. An enriched database, however, usually one in which more than 10 significant analytes are measured, can increase the sensitivity and specificity of test algorithms. Other panels can be run in addition to the panel reflecting HPA axis activity and metabolic syndrome, to further define the disease state or sub-classify patients. By way of example, data obtained from measurements of neurotrophic factors can discern patients with alterations in neuroplasticity. It is noted that such approaches also can include or be applied to other biological molecules including, without limitation, DNA and RNA.

In the construction of libraries or panels, markers and parameters can be selected using any of a variety of methods. The primary driver for construction of a disease specific library or panel can be knowledge of a parameter's relevance to the disease. To construct a library for diabetes, for example, understanding of the disease would likely warrant the inclusion of blood glucose levels. Literature searches or experimentation also can be used to identify other parameters/markers for inclusion. In the case of diabetes, for example, a literature search might indicate the potential usefulness of hemoglobin A1c (HbAC), while specific knowledge or experimentation might lead to inclusion of the inflammatory markers tumor necrosis factor (TNF)-α receptor 2 (sTNF-RII), interleukin (IL)-6, and C-reactive protein (CRP), which have been shown to be elevated in subjects with type II diabetes.

Classes of biomarkers that can be useful for diagnosing depression comorbid with pain include, for example, inflammatory biomarkers, HPA axis biomarkers, metabolic biomarkers, and neurotrophic biomarkers.

A wide variety of proteins are involved in inflammation, and any one of them is open to a genetic mutation that impairs or otherwise disrupts the normal expression and function of that protein. Inflammation also induces high systemic levels of acute-phase proteins. These proteins include C-reactive protein, serum amyloid A, serum amyloid P, vasopressin, and glucocorticoids, which cause a range of systemic effects. Inflammation also involves release of proinflammatory cytokines and chemokines. TABLE 1 provides an exemplary list of inflammatory biomarkers.

TABLE 1
Exemplary inflammatory biomarkers

| Gene Symbol | Gene Name |
|---|---|
| A1AT | Alpha 1 Antitrypsin |
| A2M | Alpha 2 Macroglobulin |
| AGP | Alpha 1-Acid Glycoprotein |
| ApoC3 | Apolipoprotein CIII |
| CD40L | CD40 ligand |
| IL-1(α or β) | Interleukin 1 |
| IL-6 | Interleukin 6 |
| IL-13 | Interleukin 13 |
| IL-18 | Interleukin 18 |
| IL-1ra | Interleukin 1 Receptor Antagonist |
| MPO | Myeloperoxidase |
| PAI-1 | Plasminogen activator inhibitor-1 |
| RANTES | RANTES (CCL5) |
| TNFA | Tumor Necrosis Factor alpha |
| sTNFR | Soluble TNFα receptor (I, II) |

The HPA axis (also referred to as the HPTA axis, or the limbic-hypothalamic-pituitary-adrenal (LHPA) axis) is a complex set of direct influences and feedback interactions between the hypothalamus, the pituitary gland, and the adrenal or suprarenal glands. The fine, homeostatic interactions between these three organs constitute the HPA axis, which is a major part of the neuroendocrine system that controls reactions to stress and regulates body processes including digestion, the immune system, mood and sexuality, and energy usage. Hypercortisolemia has been observed in patients with major depression (see, e.g., Carpenter and Bunney (1971) Am. J. Psychiatry 128:31; Carroll (1968) Lancet 1:1373; and Plotsky et al. (1998) Psychiatr. Clin. North Am. 21:293-307). True hypercortisolemia and dysregulation of the HPA axis can be found in severe forms of depression, and elements of the HPA axis appear to be state rather than trait markers, in that they respond to external stimuli. Examples of HPA axis biomarkers include those listed in TABLE 2.

TABLE 2
Exemplary HPA axis biomarkers

| Gene Symbol | Gene Name |
|---|---|
| None | Cortisol |
| EGF | Epidermal Growth Factor |
| GCSF | Granulocyte Colony Stimulating Factor |
| PPY | Pancreatic Polypeptide |
| ACTH | Adrenocorticotropic hormone |
| AVP | Arginine Vasopressin |
| CRH | Corticotropin-Releasing Hormone |

Metabolic biomarkers as defined herein refer to markers related to general health and regulation of metabolic processes, including energy metabolism. Among the possible metabolic markers that can be monitored are biomarkers related to metabolic syndrome, which is a combination of medical disorders that increase the risk of developing cardiovascular disease and diabetes. It has been suggested that depression may lead to development of cardiovascular disease through its association with metabolic syndrome. While little is known about the biochemical relationship between depression and metabolic syndrome, however, it was observed that women with a history of a major depressive episode were twice as likely to have the metabolic syndrome compared with those with no history of depression (Kinder et al. (2004) Psychosomatic Medicine 66:316-322). TABLE 3 provides an example of a list of metabolic biomarkers.

TABLE 3
Exemplary metabolic biomarkers

| Gene Symbol | Gene Name |
|---|---|
| ACRP30 | Adiponectin |
| ASP | Acylation Stimulating Protein |
| FABP | Fatty Acid Binding Protein |
| INS | Insulin |
| LEP | Leptin |
| PRL | PRL |
| RETN | RETN |
| None | Testosterone |
| TSH | Thyroid Stimulating Hormone |
| None | Thyroxine |

Neurotrophic factors are a family of proteins that are responsible for the growth and survival of developing neurons and the maintenance of mature neurons. Neurotrophic factors have been shown to promote the initial growth and development of neurons in the central nervous system (CNS) and peripheral nervous system (PNS), and to stimulate regrowth of damaged neurons in test tubes and animal models. Neurotrophic factors often are released by the target tissue in order to guide the growth of developing axons. Most neurotrophic factors belong to one of three families: (1) neurotrophins, (2) glial cell-line derived neurotrophic factor family ligands (GFLs), and (3) neuropoietic cytokines. Each family has its own distinct signaling pathway, although the cellular responses that are elicited often overlap. An exemplary list of neurotrophic biomarkers is presented in TABLE 4. Reelin is a protein that helps regulate processes of neuronal migration and positioning in the developing brain. Besides this important role in early development, reelin continues to work in the adult brain by modulating synaptic plasticity by enhancing the induction and maintenance of long-term potentiation. Reelin has been implicated in the pathogenesis of several brain diseases. Significantly lowered expression of the protein has been observed in schizophrenia and psychotic bipolar disorder. Serum levels of certain reelin isoforms may differ in MDD and other mood disorders, such that measurement of reelin isoforms can enhance the ability to distinguish MDD from bipolar disease and schizophrenia, as well as further sub-classify patient populations.

TABLE 4
Exemplary neurotrophic biomarkers

| Gene Symbol | Gene Name |
|---|---|
| BDNF | Brain-derived neurotrophic factor |
| S100B | S100B |
| NTF3 | Neurotrophin 3 |
| RELN | Reelin |
| GDNF | Glial cell line derived neurotrophic factor |
| ARTN | Artemin |

In some embodiments, a method for diagnosing or monitoring a condition such as depression or CIP can include performing a quantitative assay to obtain a measured level for one or more biomarkers (e.g., one or more, two or more, three or more, four or more, five or more, six or more, seven or more, eight or more, or all nine of the biomarkers included in TABLEs 1-4) in a biological sample (e.g., a blood, serum, plasma, or urine sample) from a subject, and comparing the measured level for each biomarker to a control measured level of each biomarker to determine whether there is a difference between each measured level and each control measured level. The control measured level of a biomarker can be, for example, the level in a normal subject (e.g., a subject without the condition) or in a population of normal subjects. In some cases, a measured level that is higher than a control measured level can be indicative of a particular condition, while in other cases, a measured level that is lower than a control measured level can be indicative of the condition. For example, the measured levels of biomarkers such as EGF, A1AT, MPO, sTNFR2, PRL, RETN, ApoCIII, and BDNF are typically higher in depressed subjects than in non-depressed subjects, while the level of cortisol typically is lower in depressed subjects than in non-depressed subjects. Thus, a difference in the level of one or more selected markers as compared to the control level of the one or more markers (e.g., a level of EGF, A1AT, MPO, sTNFR2, PRL, RETN, ApoCIII, or BDNF that is higher than a control level of EGF, A1AT, MPO, sTNFR2, PRL, RETN, ApoCIII, or BDNF, or a level of cortisol that is lower than a control level of cortisol) can indicate that a subject has depression, while the lack of such a difference may indicate that the subject does not have depression.

In some embodiments, an algorithm for diagnosing depression comorbid with pain (e.g., CIP) can include values based on the levels of one or more (e.g., one or more, two or more, three or more, four or more, five or more, six or more, seven or more, eight or more, or all nine) of cortisol, PRL, EGF, MPO, BDNF, RETN, sTNFR2, ApoC3, and A1AT. For example, an algorithm can have general Formula (5):

Diagnostic score=f(a1*cortisol+a2*PRL+a3*EGF+a4*MPO+a5*BDNF+a6*RETN+a7*sTNFR2+a8*ApoC3+a9*A1AT) (5),

where a1, a2, a3, a4, a5, a6, a7, a8, and a9 are weighting factors for the marker levels.

The weighting factors can be predetermined, and can be calculated from data obtained from measuring serum or plasma biomarker concentration in patients and controls (e.g., in 25 or more, 50 or more, or 100 or more patients, and in 25 or more, 50 or more, or 100 or more non-depressed control subjects). Individual weighting factors can be positive or negative, and each can be determined by, e.g., linear regression analysis as one that segregates MDD patients from normal subjects.

In some embodiments, a diagnostic algorithm can include other measurable parameters, such as imaging using computerized tomography (CT) scans, magnetic resonance imaging (MRI), molecular resonance spectrography (MRS), other physical measurements such as body mass index (BMI), and measures of thyroid function (e.g., TSH, free thyroxine (fT₄), free triiodothyronine (fT₃), reverse T₃ (rT₃), anti-thyroglobulin antibodies (anti-TG), anti-thyroid peroxidase antibodies (anti-TPO), fT₄/fT₃, and fT₃/rT₃). For example, to sub-classify and further characterize patients, subjects can be imaged with CT scans or MRS, including phosphorus magnetic resonance spectroscopy (³¹P-MRS). Similar studies have suggested that cerebral metabolic changes are implicated in the pathology of MDD. Experiments using ³¹P-MRS have shown that cerebral energy metabolism (e.g., beta-nucleoside triphosphate (beta-NTP), primarily reflecting brain levels of adenosine triphosphate (ATP)), is lower in depressed subjects than in normal controls, and is positively correlated with severity of depression. Beta-NTP levels also appear to correct after successful antidepressant treatment, but not in treatment of non-responders. ³¹P-MRS methods, including 3D chemical shift imaging, provide the possibility to measure ³¹P-MRS metabolites from specific brain regions.

Factors based on gender also can be included in diagnostic algorithms. For example, male-female contrasts in estrogen production throughout the reproductive years are proposed to differentially modulate the expression of depression between genders. Mood changes frequently are reported during the late luteal phase of the menstrual cycle and following childbirth. The finding of increased risk for depression at menopause has not been replicated consistently, but a recent epidemiologic study did find that the onset of major depression was increased after menopause, at a time when estrogen levels decline and post-menopausal women are increasingly vulnerable to depression due to this reduced estrogen production. Similarly, while there is a weak relationship between testosterone and depression in general, there is a much stronger relationship between testosterone and depression that does not respond to treatment.

In some embodiments, one or more values used in a diagnostic algorithm can be a logarithmic transformation of the measured level of a marker. In addition, factors based on diurnal variation in marker levels can be included in diagnostic algorithms. For example, an algorithm can be used that weights one or more biomarker concentrations based on the time of the blood draw for biomarkers whose concentration fluctuates during the day. The algorithm and weighted values are then used to calculate a serum or plasma biomarker panel based MDD score that can be used to support the diagnosis of MDD.

In one embodiment, for example, a diagnostic algorithm can have Formula (6):

Diagnostic score=(gender+CORT2+BDNF+log(MPO)+log(EGF)+gender*(PRL+RETN+sTNFRII+BMI)+A1AT+APOC3) (6),

where X*Y directs the model to include an interaction term between the variables X and Y as well as those variables themselves, and X*(Y+Z) is shorthand for X*Y+X*Z, and the values for MPO and EGF are the log-transform values. This formula also includes gender interactions for PRL, RETN, sTNFRII, and BMI in the algorithmic model, as well as the time-of-day-adjusted cortisol concentration (CORT2), used instead of the measured value.

Thus, in some embodiments, a method as provided herein can include determining (e.g., measuring) the level of each of a plurality of biomarkers in a biological sample collected from a subject having pain (e.g., a human subject diagnosed with CIP, or an animal used as a model of human disease, such as a mouse, rat, rabbit, dog, or a non-human primate). Based at least in part on the measured levels of the biomarkers, a diagnostic score can be calculated using an algorithm as set forth herein. Accordingly, in some embodiments, the biomarkers can include one or more (e.g., one or more, two or more, three or more, four or more, five or more, six or more, seven or more, eight or more, or all nine) of cortisol, PRL, EGF, MPO, BDNF, RETN, sTNFR2, ApoC3, and A1AT. When all nine markers are used, the algorithm can have a formula according to Formula (5) or Formula (6), for example. The resulting diagnostic score can be compared to a control score in order to determine whether to diagnose the subject with depression. In some embodiments, the control score can be a score determined for a population of 50 or more (e.g., 75 or more, or 100 or more) normal, non-depressed subjects. If the difference between the subject's diagnostic score and the control score is greater than a predetermined threshold, a diagnosis of depression can be made and the subject can be treated accordingly. In some cases, the predetermined threshold can be statistical significance (with p<0.05), such that a statistically significant difference between the subject's diagnostic score and the control score is indicative of depression. Methods for determining statistical significance can include, for example, those routinely used in the art (e.g., a t-statistic, a chi-square statistic, an F-statistic, etc.). In some cases, the predetermined threshold can be a difference of at least 10 percent (e.g., 10 percent, 20 percent, 25 percent, 30 percent, 40 percent, 50 percent, or more than 50 percent).

Several appropriate methods can be used to quantify the parameters included in a diagnostic/prognostic algorithm. For example, analyte measurements can be obtained using one or more medical devices or clinical evaluation scores to assess a subject's condition, or using tests of biological samples to determine the levels of particular analytes. As used herein, a “biological sample” is a sample that contains cells or cellular material, from which nucleic acids, polypeptides, or other analytes can be obtained. Depending upon the type of analysis being performed, a biological sample can be serum, plasma, or blood cells (e.g., blood cells isolated using standard techniques). Serum and plasma are exemplary biological samples, but other biological samples can be used. Examples of other suitable biological samples include, without limitation, urine, blood, serum, plasma, cerebrospinal fluid, pleural fluid, bronchial lavages, sputum, peritoneal fluid, bladder washings, secretions (e.g., breast secretions), oral washings, swabs (e.g., oral swabs), isolated cells, tissue samples, touch preps, and fine-needle aspirates. In some cases, if a biological sample is to be tested immediately, the sample can be maintained at room temperature; otherwise the sample can be refrigerated or frozen (e.g., at −80° C.) prior to assay.

Measurements can be obtained separately for individual parameters, or can be obtained simultaneously for a plurality of parameters. Any suitable platform can be used to obtain measurements for parameters. Multiplex methods can be particularly useful, as they require smaller sample volumes and perform all of the analysis at one time under the same incubation conditions. Useful platforms for simultaneously quantifying multiple parameters include, for example, those described in U.S. Provisional Application Nos. 60/910,217 and 60/824,471, U.S. Pat. No. 8,158,374, and PCT Publication No. WO2007/067819, all of which are incorporated herein by reference in their entirety. For example, the MIMS label-free assay technology (Ridge Diagnostics, Inc.; Research Triangle Park, N.C.) can be used for biomarker quantification without labeling of antigen or antibody. MIMS is nearly reagent free, is rapid, and can be readily used by non-technical individuals. Briefly, local interference at the boundary of a thin film can be the basis for optical detection technologies. For biomolecular interaction analysis, glass chips with an interference layer of SiO₂ can be used as a sensor. Molecules binding at the surface of this layer increase the optical thickness of the interference film, which can be determined as set forth in U.S. Provisional Application Nos. 60/910,217 and 60/824,471, for example.

Another example of platform useful for multiplexing is the FDA approved, flow-based Luminex assay system (xMAP; online at luminexcorp.com). This multiplex technology uses flow cytometry to detect antibody/peptide/oligonucleotide or receptor tagged and labeled microspheres. Since the system is open in architecture, Luminex can be readily adapted to host particular disease panels. Other techniques that can be used to quantify biomarkers include BIACORE™ Surface Plasmon Resonance (GE Healthcare, Chalfont St. Giles, United Kingdom) and protein arrays.

Another useful technique for analyte quantification is immunoassay, a biochemical test that measures the concentration of a substance (e.g., in a biological tissue or fluid such as serum, plasma, cerebral spinal fluid, or urine) based on the specific binding of an antibody to its antigen. Antibodies chosen for biomarker quantification must have a high affinity for their antigens. A vast array of different labels and assay strategies has been developed to meet the requirements of quantifying plasma proteins with sensitivity, accuracy, reliability, and convenience. For example, Enzyme Linked ImmunoSorbant Assay (ELISA) can be used to quantify biomarkers a biological sample. In a “solid phase sandwich ELISA,” an unknown amount of a specific “capture” antibody can be affixed to a surface of a multiwell plate, and the sample can be allowed to absorb to the capture antibody. A second specific, labeled antibody then can be washed over the surface so that it can bind to the antigen. The second antibody is linked to an enzyme, and in the final step a substance is added that can be converted by the enzyme to generate a detectable signal (e.g., a fluorescent signal). For fluorescence ELISA, a plate reader can be used to measure the signal produced when light of the appropriate wavelength is shown upon the sample. The quantification of the assays endpoint involves reading the absorbance of the colored solution in different wells on the multiwell plate. A range of plate readers are available that incorporate a spectrophotometer to allow precise measurement of the colored solution. Some automated systems, such as the BIOMEK® 1000 (Beckman Instruments, Inc.; Fullerton, Calif.), also have built-in detection systems. In general, a computer can be used to fit the unknown data points to experimentally derived concentration curves.

A number of other higher throughput, multiplexed technologies also can be used to rapidly measure and validate disease-specific and compound-specific biomarkers. These include immunobead based assays, chemiluminescent multiplex assays, and chip and protein arrays. Various protein array substrates can be used, including nylon membranes, plastic microwells, planar glass slides, gel-based arrays, and beads in suspension arrays. In addition to immunoassay-based methodology, high throughput mass spectroscopy-based technologies can be used to both establish the identity and quantify peptides and proteins. The ability of mass spectroscopy to quantify specific protein patterns associated with certain biological conditions within a complex background in an absolute quantitative way can facilitate data standardization, which can be essential for comparing biomarker expression as well as for computational biology and biosimulation.

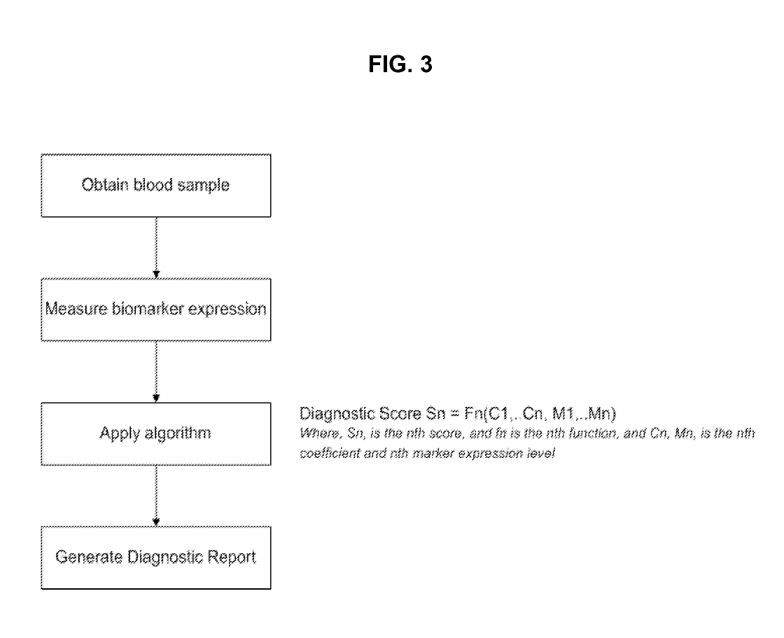

FIG. 3 is a flow diagram depicting steps that can be included in establishing set scores for diagnostic development and application. The process can involve obtaining a biological sample (e.g., a blood sample) from a subject to be tested. Depending upon the type of analysis being performed, serum, plasma, or blood cells can be isolated by standard techniques. If the biological sample is to be tested immediately, the sample can be maintained at room temperature; otherwise the sample can be refrigerated or frozen (e.g., at −80° C.) prior to assay. Biomarker expression levels can be measured using a MIMS instrument or any other suitable technology, including single assays such as ELISA or PCR, for example. Data for each marker can be collected, and an algorithm can be applied to generate a set diagnostic scores. The diagnostic scores, as well as the individual analyte levels, can be provided to a clinician for use in establishing a diagnosis and/or a treatment action for the subject.

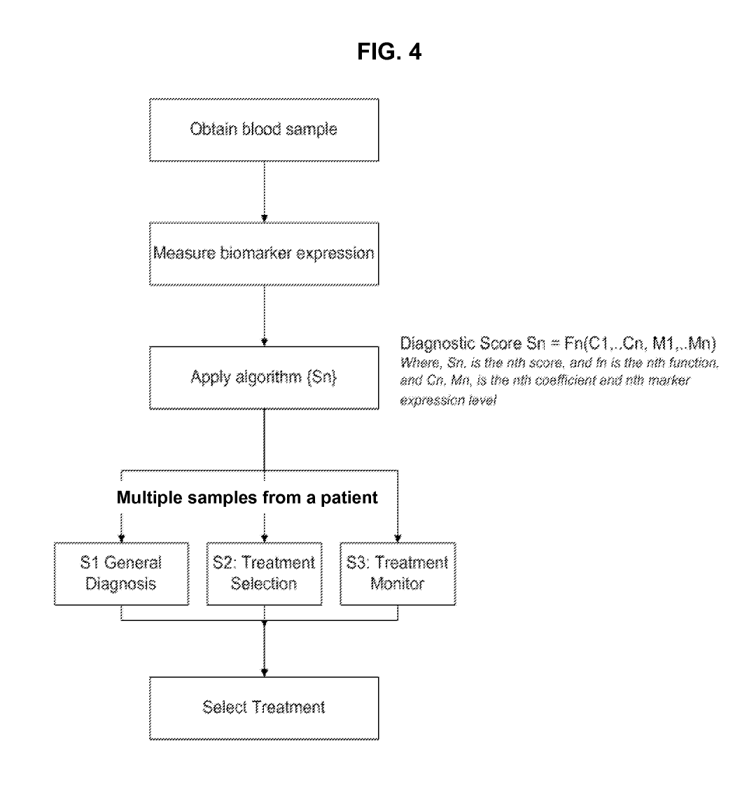

FIG. 4 is a flow diagram illustrating an exemplary process for using diagnostic scores to aid in determining diagnoses, selecting treatments, and monitoring treatment progress. As depicted in FIG. 4, one or more multiple diagnostic scores can be generated using the expression levels of a set of biomarkers. In this example, multiple biomarkers can be measured in a subject's blood sample, and three diagnostic scores are generated by the algorithm. In some cases, a single diagnostic score can be sufficient to aid in diagnosis, treatment selection, and monitoring treatment. When a treatment is selected and treatment begins, the patient can be monitored periodically by measuring biomarker levels (e.g., in a subsequently drawn blood sample), and generating and comparing diagnostic scores, as further described herein.

This document also provides methods for treating depression in pain patients (e.g., subjects diagnosed as having CIP). The methods can include, for example, measuring the level of each of at least three (e.g., three, four, five, six, seven, eight, nine, ten, or more than ten) analytes in a biological sample from a pain patient, thereby obtaining a numerical value that corresponds to the measured level for each analyte. The measured analytes can include any of those disclosed herein (e.g., in TABLEs 1-4). In some embodiments, for example, the analytes can include one or more of cortisol, PRL, EGF, MPO, BDNF, RETN, sTNFR2, ApoC3, and A1AT. Other biomarkers (e.g., clinical biomarkers such as BMI) also can be included in the calculation. In some cases, the methods can further include calculating a depression diagnostic score using an algorithm that weights each numerical value, and comparing the calculated depression diagnostic score to a control score that was calculated using the algorithm and numerical values that correspond to measured levels of the biomarkers in normal subjects. The patient can be diagnosed as having depression when the difference between the diagnostic depression score and the control score is greater than a predetermined threshold (e.g., statistical significance), and can then be treated for the depression (e.g., with an antidepressant drug such as LEXAPRO®, with transcranial magnetic stimulation, vagal nerve stimulation, electroconvulsive therapy, behavioral modification (e.g., cognitive behavioral therapy), or conventional psychotherapy.

In some embodiments, the methods provided herein can include determining whether the subject has been taking an opioid medication. Opioids (also known as narcotics) are potent analgesics that can be used to treat severe episodes of chronic pain. Non-limiting examples of opioids include morphine (e.g., AVINZA®, KADIAN®, MS CONTIN®, and ORA-MORPH® SR), codeine, oxycodone (e.g., OXYCONTIN®, PERCOCET®, PERCODAN®, and ROXICODONE®), hydromorphone (e.g., DILAUDID®), hydrocodone (e.g., VICODIN®, LORCET®, LORTAB®, and NORCO®), fentanyl (e.g., ACTIQ®, DURAGESIC®, and FENTORA®), meperidine (e.g., DEMEROL®), and methadone (e.g., DOLOPHINE® and METHADOSE™). Opioids suppress the perception of pain and calm the emotional response to pain by reducing the number of pain signals sent by the nervous system, and also be reducing the brain's reaction to pain signals. Opioids can be administered orally (e.g., in pills, liquids, or suckers), via injection or skin patch, or in suppository form. It is to be noted, however, that transdermal administration of opioids cannot be used to treat patients who have centralized pain, which is considered to be pain that may have started in the periphery but is has moved to the central nervous system (CNS), which includes the brain, brainstem, and spinal cord.

Opioids can be effective in treating severe pain, but they can be highly addictive and used beyond their indications. A study published in 2009 (Couto et al., Population Health Management 12(4):185-190) examined nearly 100,000 toxicology tests of 500,000 patients who had been prescribed opioids for chronic pain, and found that only 25 percent of the patients used their opioid medications as indicated, while 27 percent had higher drug levels than expected. In addition, opioid use may increase the risk of depressive episodes (Schemer et al., J Gen Int Med 29(3):491-499, 2014). See, also, Cheatle, Pain Med 12(Suppl s2):S43-S48, 2011. Thus, the methods provided herein also can include a step for determining the level of one or more opioid compounds in a biological sample from the subject. Based on the result, a medical professional can determine whether to adjust (e.g., increase or decrease) the subject's dosage, change the supply of opioid that the subject can have in their possession at any one time, or alter the route of administration. For example, if a biological sample from the subject contains a high level of an opioid and the subject does not have centralized pain, the route of administration for the opioid might be changed from oral to transdermal.

Measured levels of biomarkers and diagnostic scores generated by the methods provided herein can be used to monitor treatment. For example, diagnostic scores and/or individual analyte levels or biomarker values can be provided to a clinician for use in establishing or altering a course of treatment for a subject. When a treatment is selected and treatment begins, the subject can be monitored periodically by collecting biological samples at two or more intervals, measuring biomarker levels, and comparing the biomarker levels over time to determine whether they change (e.g., toward control levels). In some cases, measured levels of biomarkers at various time points can be used to generate a diagnostic score corresponding to a given time interval, and the diagnostic scores can be compared over time. On the basis of these measured levels and/or scores, and any trends observed with respect to increasing, decreasing, or stabilizing marker levels and/or diagnostic scores, a clinician, therapist, or other health-care professional may choose to continue treatment as is, to discontinue treatment, or to adjust the treatment plan with the goal of seeing improvement over time. For example, a decrease in disease severity as determined by a change in diagnostic score (e.g., toward a control score for normal individuals not having MDD) can correspond to a patient's positive response to treatment. An increase in disease severity as determined by a change in diagnostic score (e.g., away from a control score for normal individuals not having MDD), or no change in diagnostic score from a baseline level, can indicate failure to respond positively to treatment and/or the need to reevaluate the current treatment plan. A static diagnostic score can correspond to stasis with respect to disease severity. In some embodiments, a decrease in disease severity can be indicated by a change in measured marker levels toward a control measured level for normal individuals, and can correspond to a patient's positive response to treatment. Conversely, an increase in disease severity can be indicated by a change in measured marker levels away from a control measured level for normal individuals, or no change in measured marker levels from baseline levels can indicate failure to respond positively to treatment and/or the need to reevaluate the current treatment plan. Measured marker levels that do not change appreciably over time can correspond to stasis with respect to disease severity.

Diagnostic scores also can be used to stratify disease severity. In some cases, individual analyte levels and/or diagnostic scores determined by the algorithms provided herein can be provided to a clinician for use in diagnosing a subject as having mild, moderate, or severe depression. For example, diagnostic scores generated using the algorithms provided herein can be communicated by research technicians or other professionals who determine the diagnostic scores to clinicians, therapists, or other health-care professionals who will classify a subject as having a particular disease severity based on the particular score, or an increase or decrease in diagnostic score over a period of time. On the basis of these classifications, clinicians, therapists, or other health-care professionals can evaluate and recommend appropriate treatment options, educational programs, and/or other therapies with the goal of optimizing patient care. Diagnoses can be made, for example, using state of the art methodology, or can be made by a single physician or group of physicians with relevant experience with the patient population. When a patient is being monitored after treatment, movement between disease strata (i.e., mild, moderate, and severe depression) can indicate increasing or decreasing disease severity. In some cases, movement between disease strata can correspond to efficacy of the treatment plan selected for a particular subject or group of subjects.

Also provided herein are methods for treating CIP. The methods can include measuring the level of each of three or more (e.g., three, four, five, six, seven, eight, nine, ten, or more than ten) biomarkers in a biological sample from a subject suspected to have CIP, thereby obtaining a numerical value corresponding to the measured level of each biomarker. Useful biomarkers include, without limitation, those listed in TABLEs 1-4. In some embodiments, the three or more biomarkers can be selected from the group consisting of cortisol, PRL, EGF, MPO, BDNF, RETN, sTNFR2, ApoC3, and A1AT; other clinical biomarkers such as BMI also may be included. Methods for treating CIP also can include calculating a CIP diagnostic score using an algorithm that weights each numerical value, and comparing the calculated CIP diagnostic score to a control score that was calculated using the algorithm and numerical values corresponding to control measured levels of the biomarkers (e.g., measured levels in normal subjects). If the difference between the CIP diagnostic score and the control score is greater than a predetermined threshold, the subject can be diagnosed as having CIP, and can be treated for the CIP. Suitable treatments include, without limitation, opioids, hormones, anticonvulsants (e.g. gabapentin), acupuncture, electrical stimulation, nerve blocks, and surgery.

In some cases, a method can include treating pain (e.g., CIP) and depression. For example, a method can include identifying a patient being treated for pain, testing the patient for depression (e.g., using a method as described herein), and, if the patient is identified as having depression, treating the depression in the patient. If the patient is not determined to have depression, the method may include re-testing the patient for depression after a period of time (e.g., at least one month, at least two months, at last three months, at least four months, at least five months, at least six months, one to three months, three to six months, or one to six months). In addition, the method can include maintaining the pain treatment.

In some embodiments, a method for treating pain and depression can include identifying a patient with CIP, administering pain medication or pain therapy to the patient, testing the patient for depression (e.g., using a method as described herein), and if the patient is determined to have depression, treating the depression. If the patient is determined not to have depression, the patient can be re-tested for depression after a period of time (e.g., at least one month, at least two months, at least three months, at least four months, at least five months, at least six months, one to three months, three to six months, or one to six months).

This document also provides methods that can be used to monitor a pain patient for depression. For example, a method can include identifying a pain patient, obtaining a biological sample from the patient at least once every three months (e.g., once every three months, once every two months, every month, or every two weeks) over the course of at least six months (e.g., six months, nine months, twelve months, or more than twelve months), and analyzing the biological samples to determine whether the patient has depression. If the patient is determined to have depression, the method can further include treating the depression. The step of analyzing the biological samples to determine whether the patient has depression can be carried out as described herein. For example, an analyzing step can include performing a quantitative assay to measure the level of each of at least three (e.g., three, four, five, six, seven, eight, or nine) biomarkers in a biological sample from the patient, to obtain a numerical value corresponding to the measured level of each biomarker, where the at least three biomarkers are selected from the group consisting of cortisol, PRL, EGF, MPO, BDNF, RETN, sTNFR2, ApoC3, and A1AT. The step can further include calculating a depression diagnostic score using an algorithm that weights each numerical value, and comparing the calculated depression diagnostic score to a control score calculated using the algorithm and numerical values corresponding to measured levels of the biomarkers in normal subjects. The patient can be determined to have depression when the difference between the diagnostic depression score and the control score is greater than a predetermined threshold.

In some embodiments, the methods provided herein can include the use of biomarker hypermapping (BHM) technology, which represents a methodology to both visualize patterns associated with the disease state as well as sub-classification of patient groups or individual patients based upon a pattern.

Commonly, methods related to multi-analyte diagnostics typically use either a global optimization method in which all the markers (parameters) are used in multivariable optimization to best fit the clinical study results, or use a decision tree methodology. Decision trees can be used to determine the best way to distinguish individuals with a disease from normal subjects in a clinical setting. Many of these methods are effective when the number of analyzes are small (typically less than 5). In such situations, experts as well as those less skilled can make a diagnosis independent of significant insight into the underlying biology of the disease or the tests employed. For complex diseases, however, where symptoms overlap and there can be significant variation between stages of disease, a larger number of analytes are required to diagnose or sub-classify patients. In such cases, many parameters need to be taken into account, and the contribution of each parameter (analyte) is small. Even experts can have a hard time gaining insight into the status of an individual patient. Similarly, medical researchers looking at the underlying biology of a disease or hoping to develop new therapeutics may miss useful information by performing a simple global optimization.

The BMH approach uses biomarkers reflective of different physiologic parameters (e.g., hormones, metabolic markers, and inflammatory markers) to construct a visualization of changes in biomarker expression that may be related to disease state. In this process, a patient's biomarker responses are mapped onto a multi-dimensional hyperspace. Distinct coefficients can be derived to create hyperspace vectors for subsets of patients and age-matched normal subjects. Multiplex biomarker data from clinical sample sets can be used iteratively to construct and define a hyperspace map, which then can be used to separate disease states from normal states and provide guidance in treatment plans. Exemplary methods for generating hypermaps to assess depression are disclosed in U.S. Publication No. 2010/0100333, which is incorporated herein by reference in its entirety.

In general, the methods described herein are directed to analysis of multi-analyte diagnostic tests. These methods can be particular useful with complex diseases, for which it can be difficult to distinguish different patient sub-groups (e.g., groups with different prognoses or manifestations of disease) or even to distinguish affected from normal subjects, based on only one or two markers. Multiple markers (e.g., 2, 3, 4, 5, or more than 5 markers) can be used in combination in the presently described methods to provide increased power of a diagnostic test, allowing clinicians to discriminate between patients and prevent confounding co-morbidities from other diseases from interfering with sensitivity and specificity, for example.

Different groups of markers can be selected based on physiologic/biologic functions related to a disease of interest by use of direct analysis of clinical studies and/or bioinformatics. Using a large library of biomarkers, markers can be grouped according to functional activity that reflects different segments of human physiology and/or biologic processes. Within each group, multiple markers can be used to provide an accurate measurement of the physiologic or biologic changes within each process or system. For analysis of complex diseases, multiple groups can be used for measurement of whole body changes under a particular disease condition.

Rather than performing a global optimization for all measured markers in all related groups within a body of clinical study data, the methods provided herein can first include optimization of the measured markers in each functional group using clinical study data. The optimized results for each group can be used to construct a combination parameter that represents the group in the construction of a preliminary hypermap of the disease. Data from multiple studies can be used iteratively to further develop the disease hypermap. The data from individual patients then can be mapped to the disease hypermap in order to take advantage of what is known about previously characterized patients whose biomarker profiles fall within the same multi-dimensional space. Knowledge gained from analysis of previously characterized patients can be used to sub-categorize the patient, predict disease course, and make decisions regarding, for example, treatment options (e.g., drugs of choice and other potentially successful therapeutic approaches).

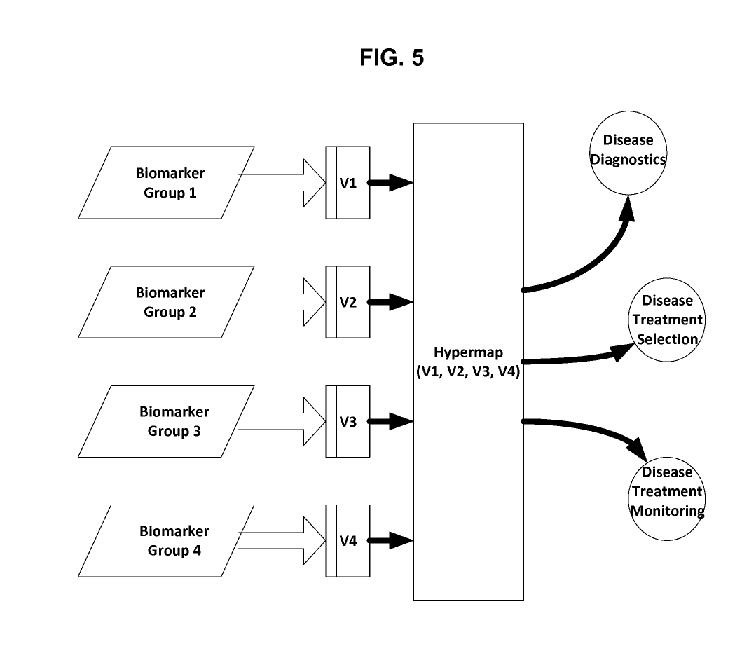

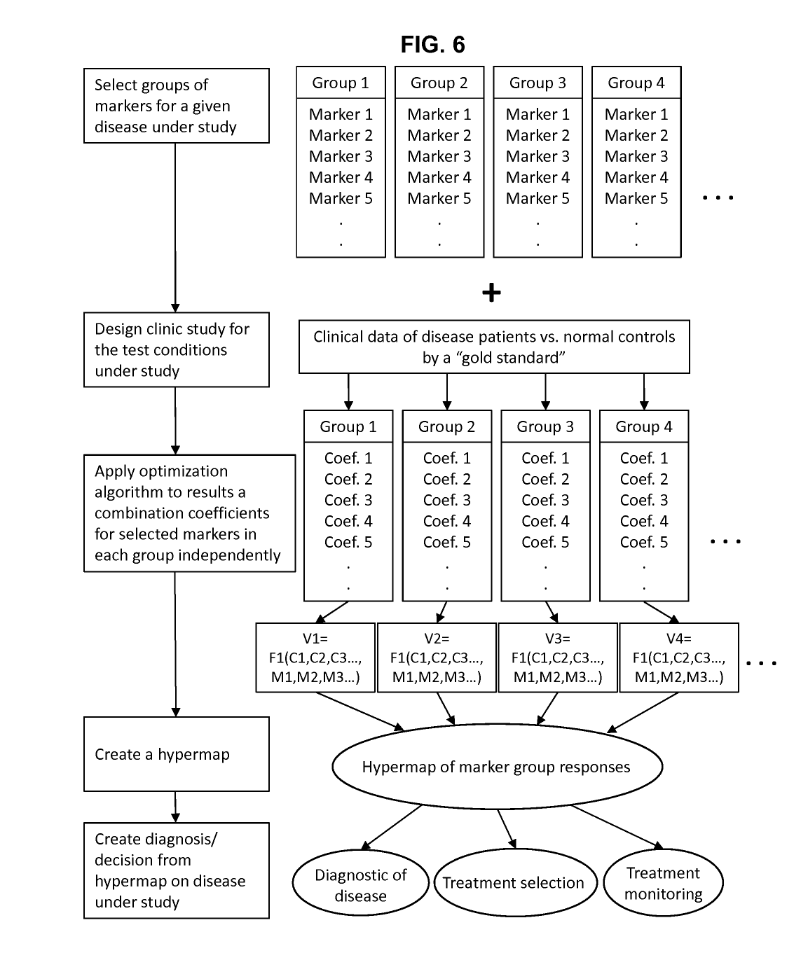

FIGS. 5 and 6 illustrate processes for constructing hypermaps from selected groups, markers, and clinical data for a given disease. As shown, several steps can be used to create a hypermap for a disease of interest. In some embodiments, the first step can be to select groups of markers, based on the physiology and biology of the disease, as well as current understanding of biomarker responses within the disease state. Many diseases have shared elements that include inflammation, tissue remodeling, metabolic changes, immune response, cell migration, hormonal imbalance, etc. Certain diseases are associated with pain or neurologic dysfunction, or there may be specific markers that are characteristic of a specific disease (e.g., elevated blood glucose in diabetes) or response to a specific drug (e.g., estrogen receptor expression in breast cancer patients). Biomarkers can be grouped differently, essentially via functional clustering, which can provide more information relative to the pathways involved in physiological dysfunctions. In inflammation, for example, markers can include those related to the acute phase response (e.g., C-reactive protein), the cytokine response (e.g., Th1- and Th2-related interleukins), chemokines, and chemoattractant molecules (e.g., IL-8 in the attraction of neutrophils into the lung that is characteristic of certain respiratory diseases).

Information regarding biomarkers and hypermapping as discussed herein can be used for, without limitation, treatment monitoring. For example, hypermapping information can be provided to a clinician for use in establishing or altering a course of treatment for a subject. When a treatment is selected and treatment starts, the subject can be monitored periodically by collecting biological samples at two or more intervals, generating hypermapping information corresponding to a given time interval pre- and post-treatment, and comparing the result of hypermaps over time. On the basis of such hypermapping information and any trends observed with respect to increasing, decreasing, or stabilizing biomarker levels, for example, a clinician, therapist, or other health-care professional may choose to continue treatment as is, to discontinue treatment, or to adjust the treatment plan with the goal of seeing improvement over time.

After a patient's biomarker and/or hypemapping information is reported, a health-care professional can take one or more actions that can affect patient care. For example, a health-care professional can record the information and biomarker expression levels in a patient's medical record. In some cases, a health-care professional can record a diagnosis of a neuropsychiatric disease, or otherwise transform the patient's medical record, to reflect the patient's medical condition. In some cases, a health-care professional can review and evaluate a patient's medical record, and can assess multiple treatment strategies for clinical intervention of a patient's condition.

For major depressive disorder and other mood disorders, treatment monitoring can help a clinician adjust treatment dose(s) and duration. An indication of a subset of alterations in hypermapping information that more closely resemble normal homeostasis can assist a clinician in assessing the efficacy of a regimen. A health-care professional can initiate or modify treatment for symptoms of depression and other neuropsychiatric diseases after receiving information regarding a patient's hypermapping result. In some cases, previous reports of hypermapping information can be compared with recently communicated hypermapping information. On the basis of such comparison, a health-care profession may recommend a change in therapy. In some cases, a health-care professional can enroll a patient in a clinical trial for novel therapeutic intervention of MDD symptoms. In some cases, a health-care professional can elect waiting to begin therapy until the patient's symptoms require clinical intervention.

A health-care professional can communicate information regarding or derived from biomarker levels, diagnostic score(s), and/or hypermapping to a patient or a patient's family. In some cases, a health-care professional can provide a patient and/or a patient's family with information regarding MDD, including treatment options, prognosis, and referrals to specialists, e.g., pain specialists, neurologists, and/or counselors. In some cases, a health-care professional can provide a copy of a patient's medical records to communicate biomarker information, diagnostic score(s), and/or hypermapping information to a specialist.

A research professional can apply information regarding a subject's biomarker levels, diagnostic score(s), and/or hypermapping information to advance research into pain and depression. For example, a researcher can compile data on hypermaps with information regarding the efficacy of a drug for treatment of pain or depression, or the symptoms of other neuropsychiatric diseases, to identify an effective treatment. In some cases, a research professional can obtain a subject's biomarker, diagnostic, and/or hypermapping information to evaluate a subject's enrollment or continued participation in a research study or clinical trial. In some cases, a research professional can communicate a subject's biomarker, diagnostic, and/or hypermapping information to a health-care professional, and/or can refer a subject to a health-care professional for clinical assessment and treatment.

Several appropriate methods can be used to communicate information to another person (e.g., a professional), and information can be communicated directly or indirectly. For example, a laboratory technician can input vector information, biomarker levels, and/or hypermapping outcome information into a computer-based record. In some cases, information can be communicated by making a physical alteration to medical or research records. For example, a medical professional can make a permanent notation or flag a medical record for communicating a diagnosis to other health-care professionals reviewing the record. Any type of communication can be used (e.g., mail, e-mail, telephone, facsimile and face-to-face interactions). Secure types of communication (e.g., facsimile, mail, and face-to-face interactions) can be particularly useful. Information also can be communicated to a professional by making that information electronically available (e.g., in a secure manner) to the professional. For example, information can be placed on a computer database such that a health-care professional can access the information. In addition, information can be communicated to a hospital, clinic, or research facility serving as an agent for the professional. Information transferred over open networks (e.g., the internet or e-mail) can be encrypted. When closed systems or networks are used, existing access controls may be sufficient.

As noted above, the methods provided herein can be computer-based. Thus, this document also provides an apparatus or a system that includes one or more computer processors, and computer memory in communication with the one or more processors, where the memory stores instructions that, when executed, perform operations to carry out the steps for determining a diagnostic score. As such, this document provides a system with means for carrying out each step of the methods provided herein.

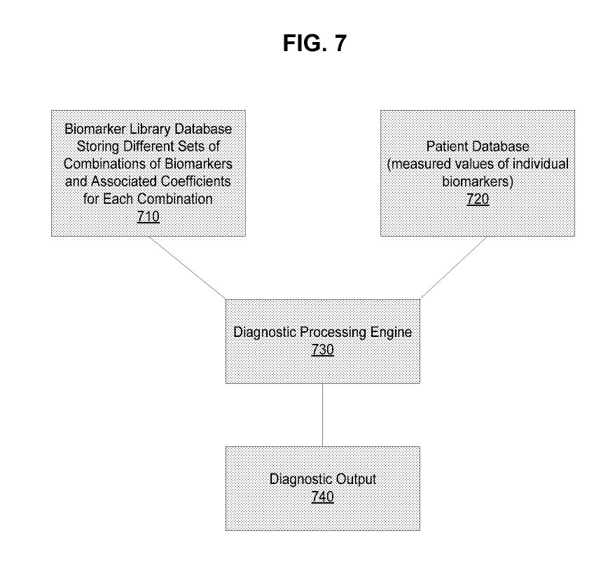

FIG. 7 shows an example of a computer-based diagnostic system employing the biomarker analysis described above. This system includes a biomarker library database 710 that stores different sets combinations of biomarkers and associated coefficients for each combination based on biomarker algorithms which are generated based on, e.g., the method shown in FIG. 1 or 2. The database 710 is stored in a digital storage device in the system. A patient database 720 is provided in this system to store measured values of individual biomarkers of one or more patients under analysis. A diagnostic processing engine 730, which can be implemented by one or more computer processors, is provided to apply one or more sets of combinations of biomarkers in the biomarker library database 710 to the patient data of a particular patient stored in the database 720 to generate diagnostic output for a set of combination of biomarkers that is selected for diagnosing the patient. Two or more such sets may be applied to the patient data to provide two or more different diagnostic output results. The output of the processing engine 730 can be stored in an output device 740, which can be, e.g., a display device, a printer, or a database.

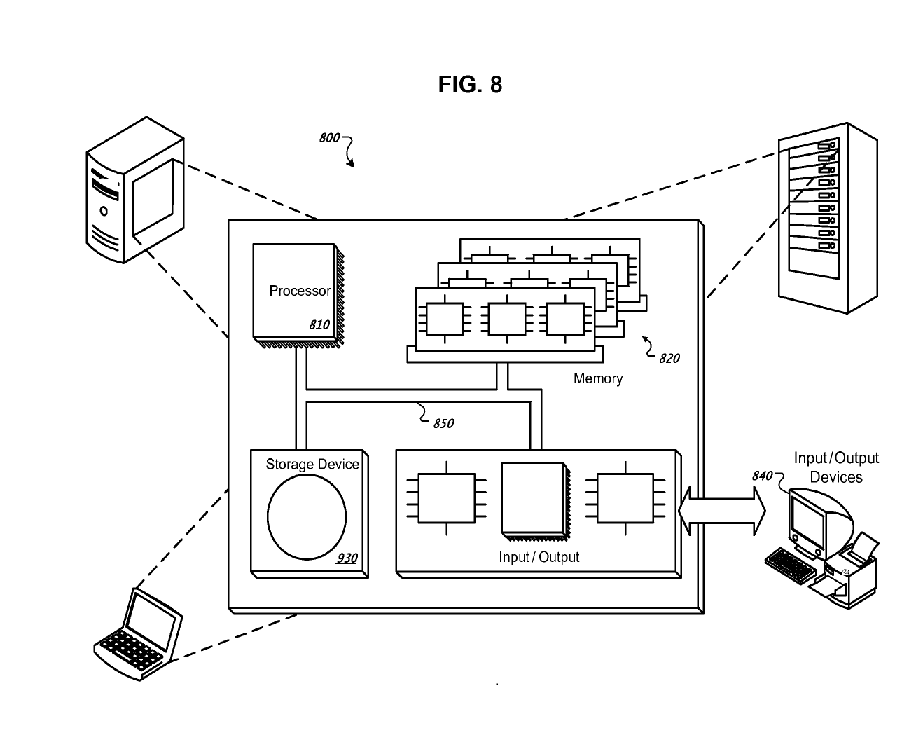

One or more computer systems can be used to implement the system in FIG. 7 and for the operations described in association with any of the computer-implement methods described in this document. FIG. 8 shows an example of such a computer system 800. The system 800 can include various forms of digital computers, such as laptops, desktops, workstations, personal digital assistants, servers, blade servers, mainframes, and other appropriate computers. The system 800 can also include mobile devices, such as personal digital assistants, cellular telephones, smartphones, and other similar computing devices. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

In the specific example in FIG. 8, the system 800 includes a processor 810, a memory 820, a storage device 830, and an input/output device 840. Each of the components 810, 820, 830, and 840 are interconnected using a system bus 850. The processor 810 is capable of processing instructions for execution within the system 800. The processor may be designed using any of a number of architectures. For example, the processor 810 may be a CISC (Complex Instruction Set Computers) processor, a RISC (Reduced Instruction Set Computer) processor, or a MISC (Minimal Instruction Set Computer) processor.

In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840.

The memory 820 stores information within the system 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the system 800. In one implementation, the storage device 830 is a computer-readable medium. In various different implementations, the storage device 830 may be a floppy disk device, a hard disk device, an optical disk device, or a tape device.

The input/output device 840 provides input/output operations for the system 800. In one implementation, the input/output device 840 includes a keyboard and/or pointing device. In another implementation, the input/output device 840 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

In another aspect, this document provides article of manufactures that can be used to collect one or more biological samples for determination of opioid levels and biomarker levels. For example, this document provides a vessel having two or more chambers, with a first chamber configured to receive a blood sample and a second chamber configured to receive a urine sample. The chamber for receiving a blood sample can contain an anticoagulant (e.g., heparin), for example. The chamber for receiving a urine sample can contain one or more specific opioid receptors or antibody reagents for detecting and/or indicating whether an opioid or opioid metabolite is present in the urine sample. In some cases, an article of manufacture can include two or more chambers that are both configured to receive a blood sample, where the blood sample from one chamber can be used for determination of opioid levels, and the blood sample from the other chamber can be used for determination of biomarker levels. Such articles of manufacture can be made from materials such as fluorinated ethylene propylene (FEP), polytetrafluoroethylene (PTFE), or polycarbonate, for example. Each chamber can be sized to contain a suitable volume of blood or urine for conducting the opioid or biomarker assay. For example, each chamber can hold at least 50 μl (e.g., at least 50 μl, at least 100 μl, at least 200 μl, at least 250 μl, at least 300 μl, at least 400 μl, or at least 500 μl) of blood, serum, or urine. Newer immunoassay technologies have very good sensitivity and specificity, which can obviate the need for GC/MS unless there are forensic requirements (e.g., post mortem confirmatory evidence). In some embodiments, an article of manufacture can have a first portion configured to receive a blood sample (e.g., a sample to be analyzed for levels of biomarkers indicative of depression), and a second portion configured for receiving a urine sample (e.g., a urine sample to be analyzed for opioid levels). Since opioids also can be measured in saliva (albeit though less sensitive and less qualitative technologies), in some embodiments an article of manufacture can include a second portion configured to receive a saliva sample. In such embodiments, the second portion also can include a swab for collecting a saliva sample. The articles of manufacture can be used by medical or research professionals for collecting biological samples, which can then be analyzed at or near the location of collection, or can be shipped for analysis at a separate location (e.g., with or without freezing).

The invention will be further described in the following examples, which do not limit the scope of the invention described in the claims.

### EXAMPLES

### Example 1

An MDDSCORE™ was calculated for each of 39 CIP patients (24 females and 15 males). The MDDSCORE™ was used to characterize contributions of the inflammatory, HPA axis, metabolic, and neurotrophic pathways in CIP. A summary of median MDDSCOREs™, as well as median serum levels of TSH and median BMI, is shown in TABLE 5. TABLEs 6-8 provide summaries of median serum levels of the inflammatory biomarkers A1AT, MPO, and sTNFR2 (TABLE 6), median serum levels of the HPA axis biomarkers cortisol and EGF (TABLE 7), and median serum levels of the metabolic biomarkers PRL, RETN, and ApoCIII (TABLE 8). With the exception of PRL (TABLE 8), there were no significant differences in marker levels between male and female CIP patients.

TABLE 5

| Group | Number | MDDSCORE ™ | TSH Level^{†} | BMI |
|---|---|---|---|---|
| FEMALE CIP | 24 | 6 | 1.25 | 24.8 |
| MALE CIP | 15 | 5 | 1.6 | 27.7 |
| t test^{‡} | | p = 0.63 | p = 0.53 | p = 0.70 |

^{†}TSH serum level (μIU/mL)
^{‡}p value from T test comparing male and female CIP patients

TABLE 6

| Group | A1AT^{†} | MPO^{‡} | sTNFR2^{§} |
|---|---|---|---|
| FEMALE CIP | 173.5 | 291.5 | 3051.5 |
| MALE CIP | 168 | 311 | 2786 |
| t test (by gender) | p = 0.27 | p = 0.8 | p = 0.5 |

^{†}A1AT serum level (mg/dL)
^{‡}MPO serum level (ng/mL)
^{§}sTNFR2 serum level (pg/mL)

TABLE 7

| Group | Cortisol^{†} | EGF^{‡} |
|---|---|---|
| FEMALE CIP, median | 6.75 | 341 |
| MALE CIP, median | 7.5 | 236 |
| t test (by gender) | p = 0.52 | p = 0.7 |

^{†}cortisol serum level (μg/dL)
^{‡}EGF serum level (pg/mL)

TABLE 8

| Group | PRL^{†} | RETN^{‡} | ApoCIII^{§} |
|---|---|---|---|
| FEMALE CIP | 15.7 | 10 | 10.1 |
| MALE CIP | 8.4 | 8.5 | 10.6 |
| t test (by gender) | p = 0.016 | p = 0.17 | p = 0.84 |

^{†}PRL serum level (ng/mL) is significantly different between the genders
^{‡}RETN serum level (ng/mL)
^{§}ApoCIII serum level (mg/dL)

Analysis using the MDDSCORE™ biomarker panel and accompanying algorithm indicated that 54% of the patients (13 females and 8 males) had an MDDSCORE™≧5, a result consistent with a greater than 90% chance of a diagnosis of MDD. After treatment for their pain, every patient reported improvement in depression, hopelessness, and quality of life measures. This study also revealed that over half (56.4%) of an “apparent” stabilized group of CIP patients had measurable residual or unresolved inflammation, consistent with a number of prior studies supporting the concept that inflammatory mechanisms and dysregulation of the HPA axis play a crucial role in the pathophysiology of MDD. Additionally, this study supports clinical research findings that excess inflammation and hyper-arousal of the HPA axis are major clinical problems with CIP.

### Example 2

An MDDSCORE™ was calculated for each of 20 CIP patients and 86 normal control subjects. The MDDSCORE™ was used to characterize contributions of the inflammatory, HPA axis, metabolic, and neurotrophic pathways in CIP. A summary of median MDDSCOREs™, as well as median serum levels of cortisol and EGF, is shown in TABLE 9. A summary of median serum levels of the inflammatory biomarkers A1AT, MPO, and sTNFR2 is shown in TABLE 10.

TABLE 9

| Group | MDDSCORE ™^{†} | Cortisol^{‡} | EGF^{§} |
|---|---|---|---|
| FEMALE CIP | 6 | 6.75 | 341 |
| MALE CIP | 5 | 7.5 | 236 |
| FEMALE Normal | 1 | 14 | 159 |
| MALE Normal | 1 | 12 | 141 |
| t test (Normal v. CIP)^{¶} | p = >0.00001 | p = 0.0008 | p = 0.0005 |

^{†}MDDSCORE ™ median
^{‡}Cortisol median serum levels (μg/dL)
^{§}EGF median serum levels (pg/mL)
^{¶}p values determined by T test for the comparison of normal subjects to CIP patients

TABLE 10

| Group | A1AT^{†} | MPO^{‡} | sTNFR2^{§} |
|---|---|---|---|
| FEMALE CIP | 173.5 | 291.5 | 3051.5 |
| MALE CIP | 168 | 311 | 2786 |
| FEMALE Normal | 154 | 170 | 2252 |
| MALE Normal | 139 | 154 | 2503 |
| t test (Normal v. CIP)^{¶} | p = 0.000129 | p < 0.00001 | p = 0.0145 |

^{†}A1AT serum level (mg/dL)
^{‡}MPO serum level (ng/mL)
^{§}sTNFR2 serum level (pg/mL)
^{¶}p values determined by T test for the comparison of normal subjects to CIP patients

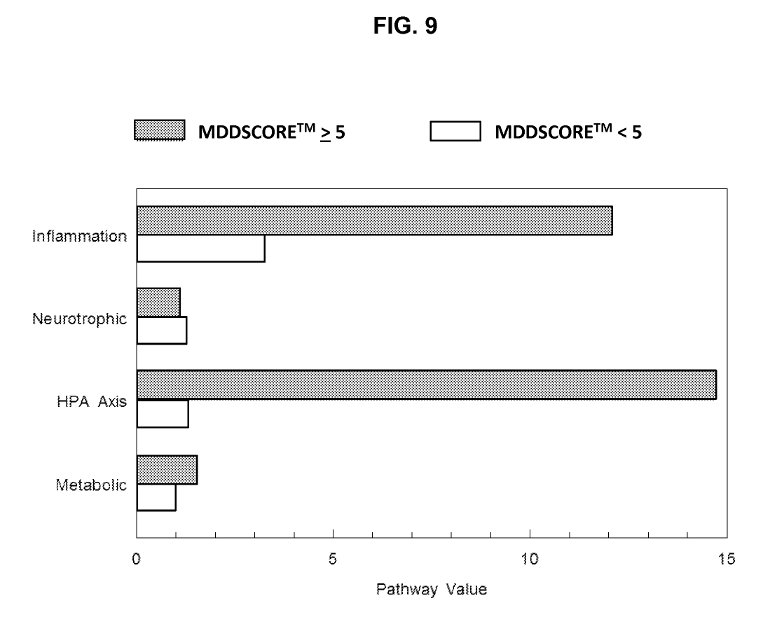

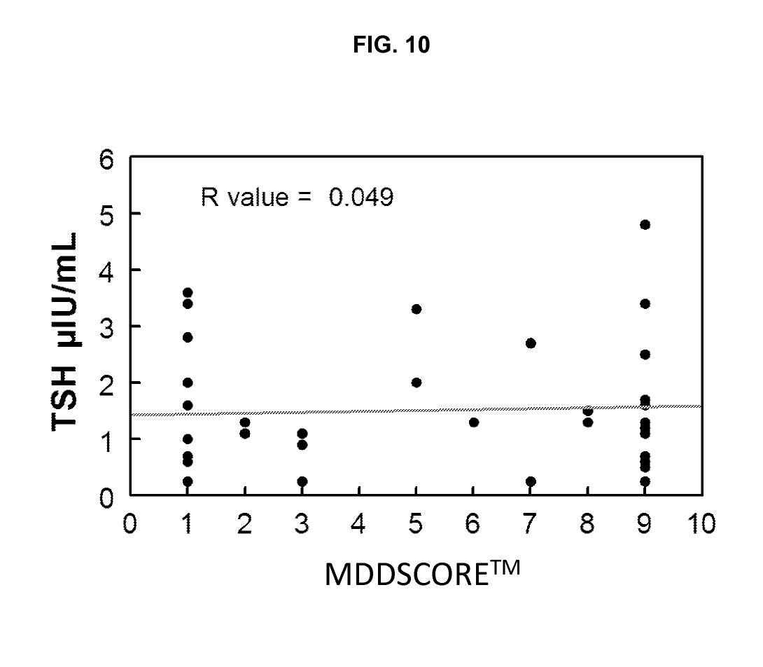

The CIP study subjects were segregated into two populations based on their MDDSCORE™—those with a score less than five, and those with a score greater than or equal to five, and the median serum levels of inflammatory, neurotropic, HPA axis, and metabolic biomarkers were compared between the two groups. As shown in TABLE 11 and FIG. 9, levels of the HPA axis biomarkers that were evaluated were nearly 11.6-fold higher in CIP patients with a MDDSCORE™≧5 than in patients having a MDDSCORE™<5. The inflammatory biomarkers measured were increased nearly 3.7-fold in CIP patients with a MDDSCORE™>5, as compared to patients having a MDDSCORE™<5. In contrast, levels of TSH showed no correlation with MDDSCORE™ (FIG. 10).

TABLE 11

| | | | Fold |
|---|---|---|---|
| Pathway | MDDSCORE ™ ≧5 | MDDSCORE ™ <5 | Difference |
| Inflammatory | 12.09 | 3.28 | 3.68 |
| Neurotrophic | 1.03 | 1.23 | 0.84 |
| HPA Axis | 14.70 | 1.27 | 11.57 |
| Metabolic | 1.51 | 0.96 | 1.57 |

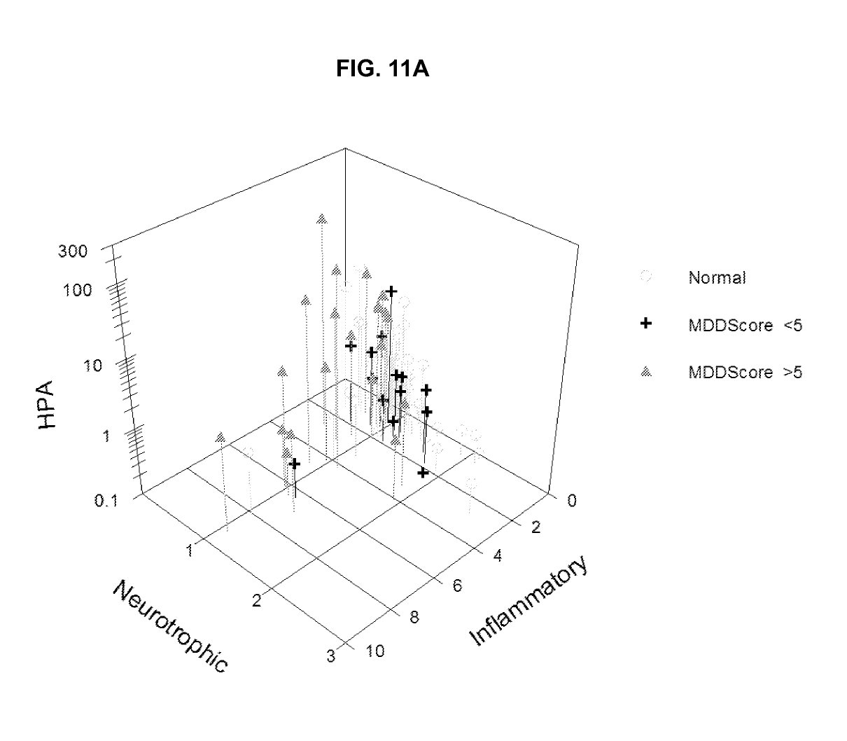

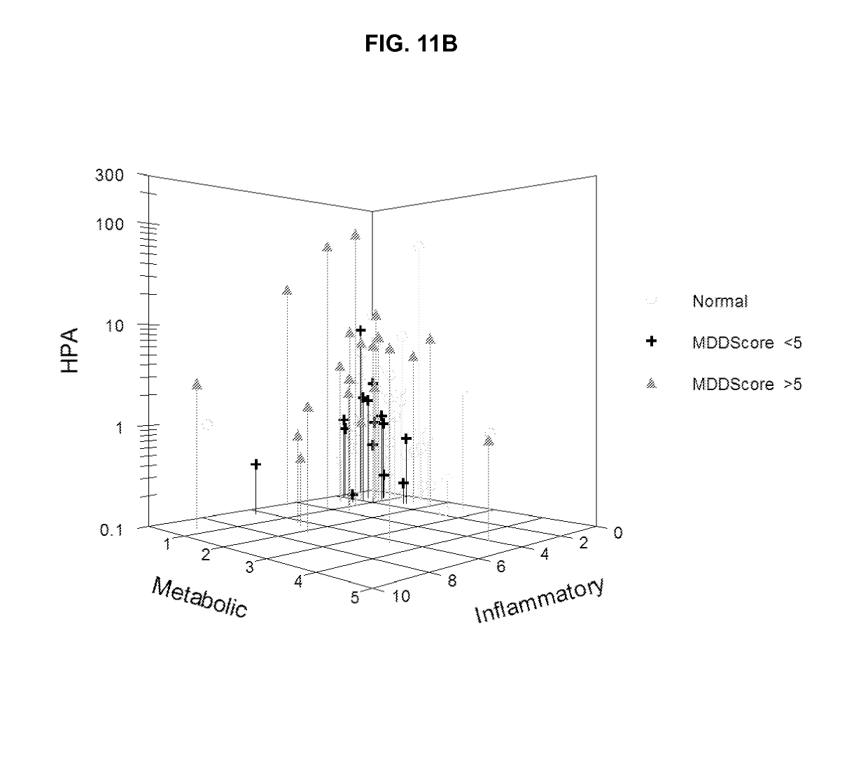

Hypermaps were generated to plot and compare the levels of markers in various combinations of the four pathways in the two CIP groups and the normal controls; these are shown in FIG. 11A (HPA, neurotrophic, and inflammatory) and 11B (HPA, metabolic, and inflammatory).

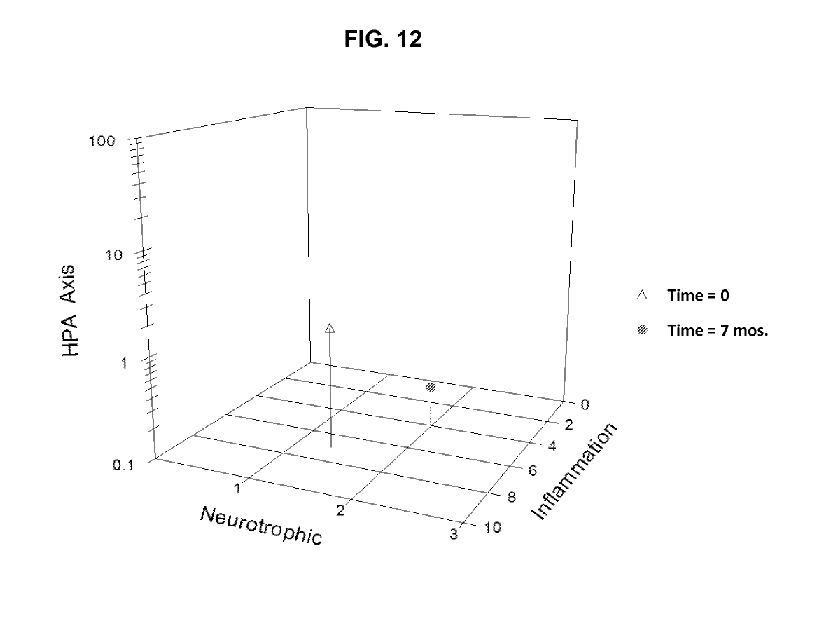

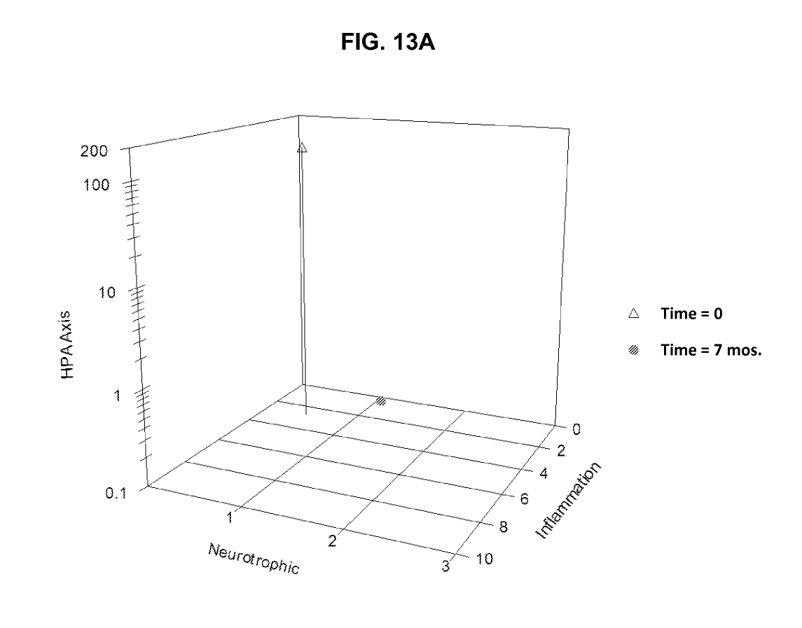

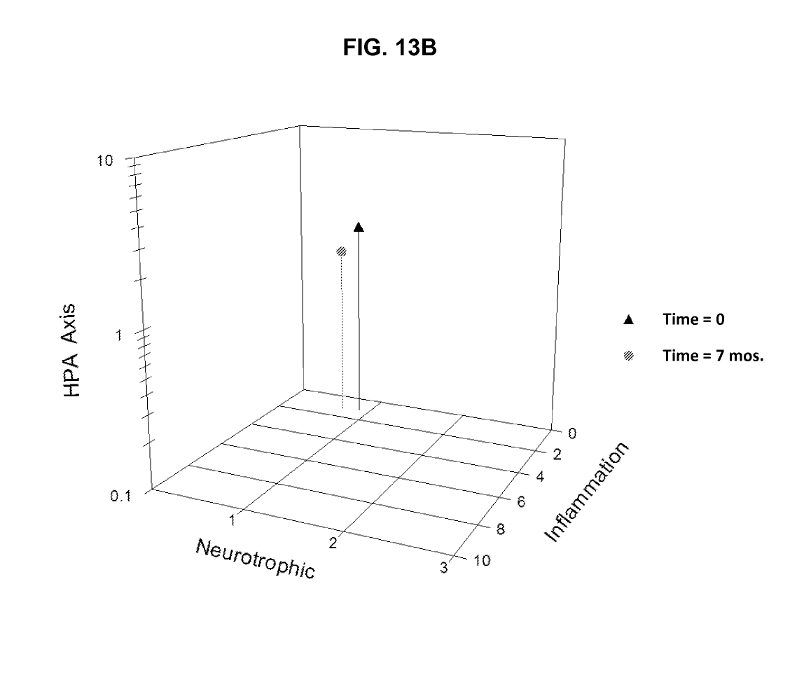

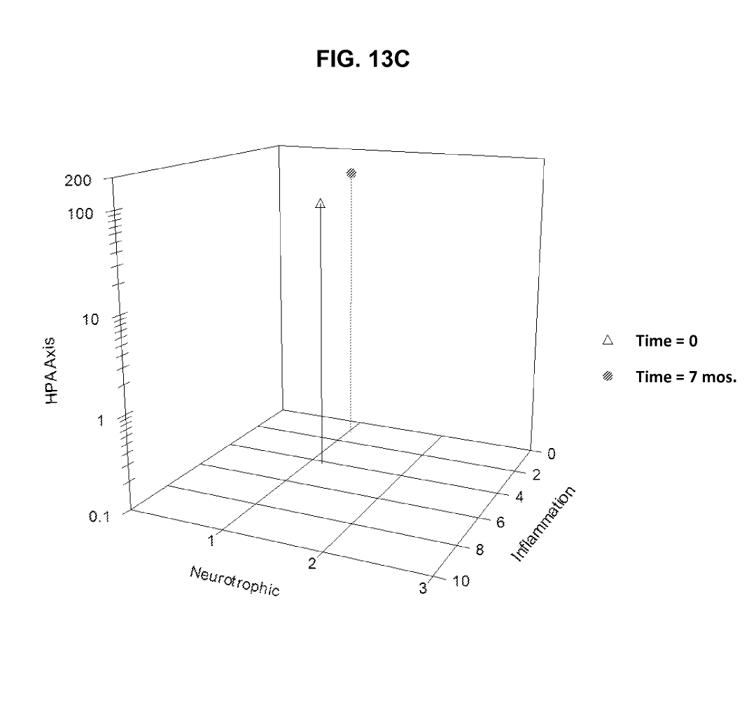

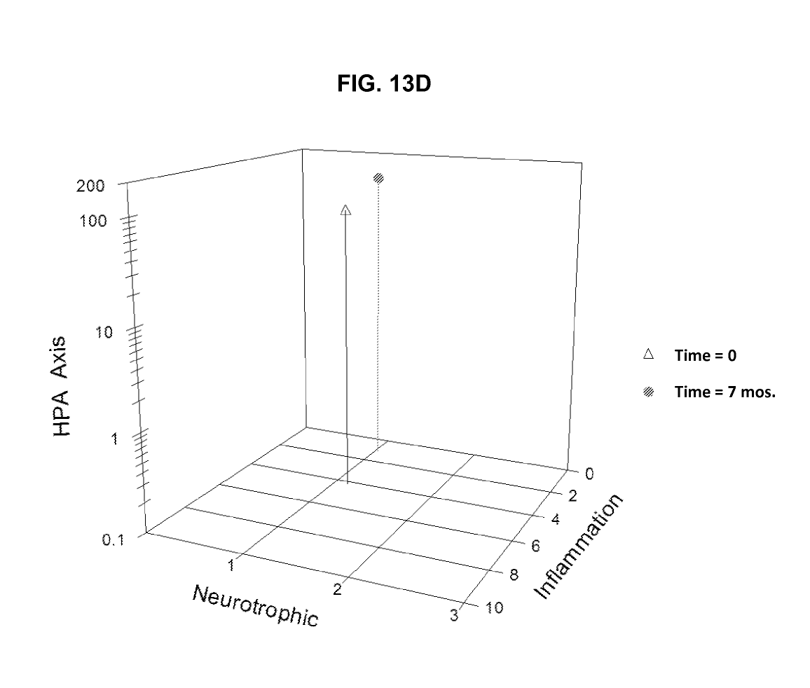

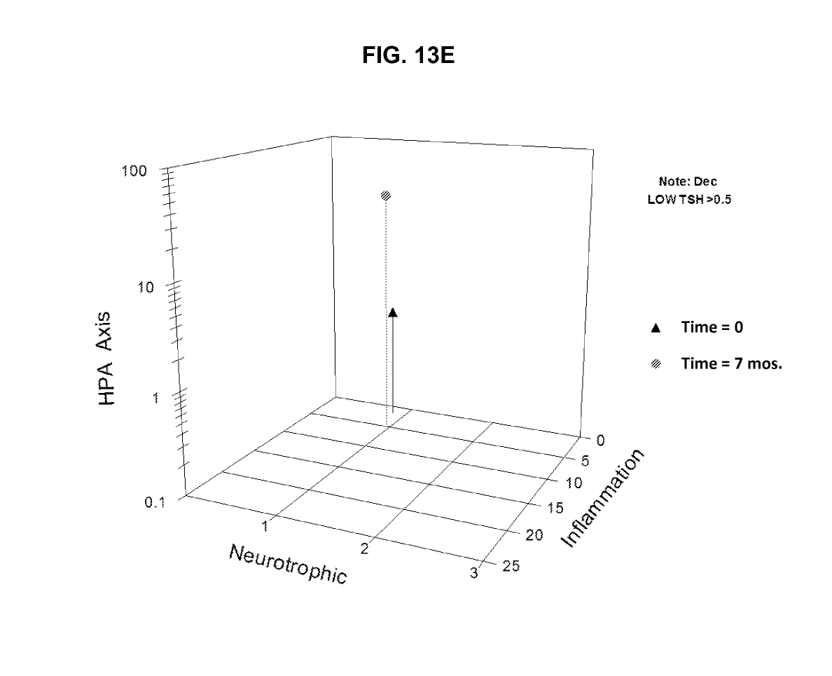

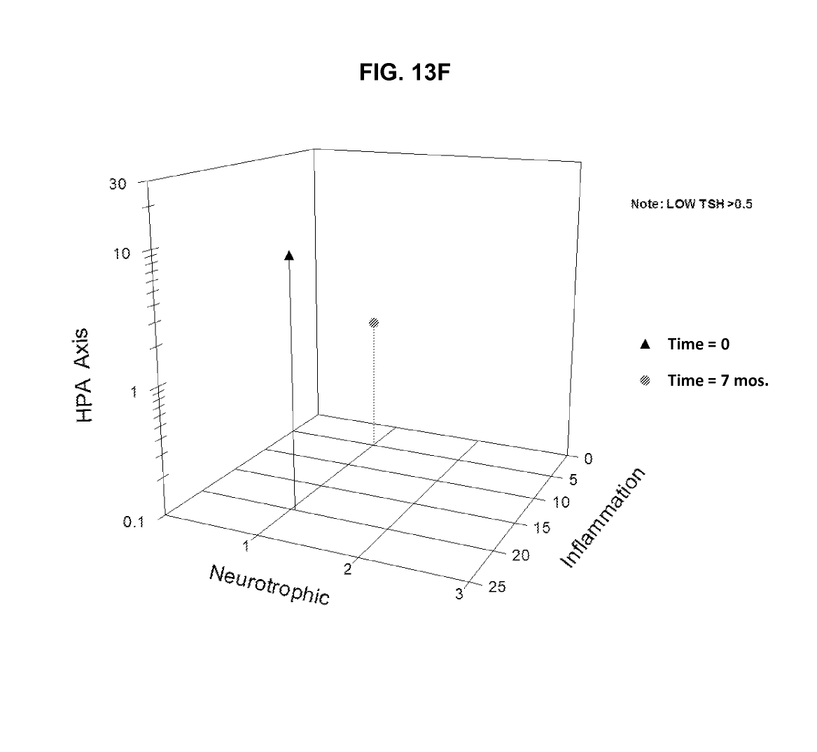

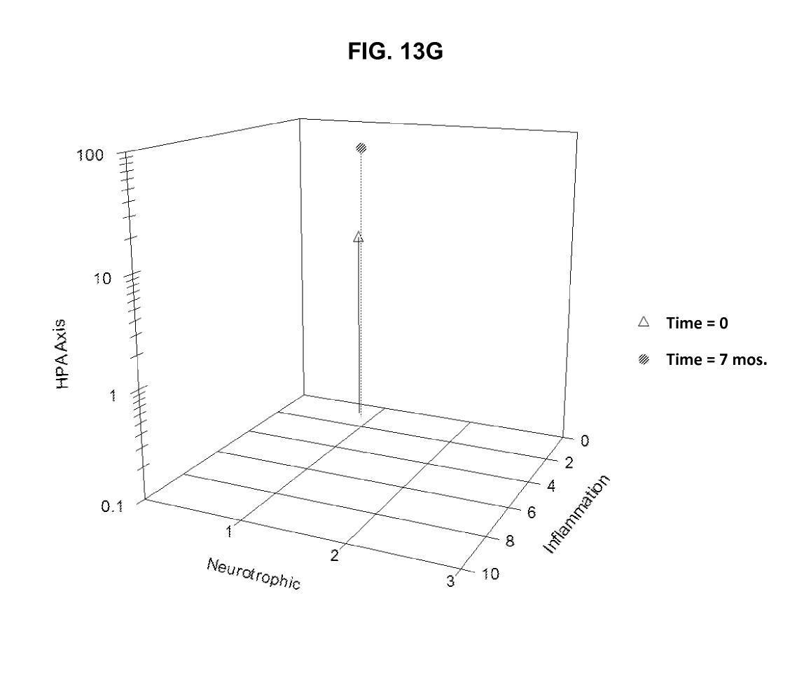

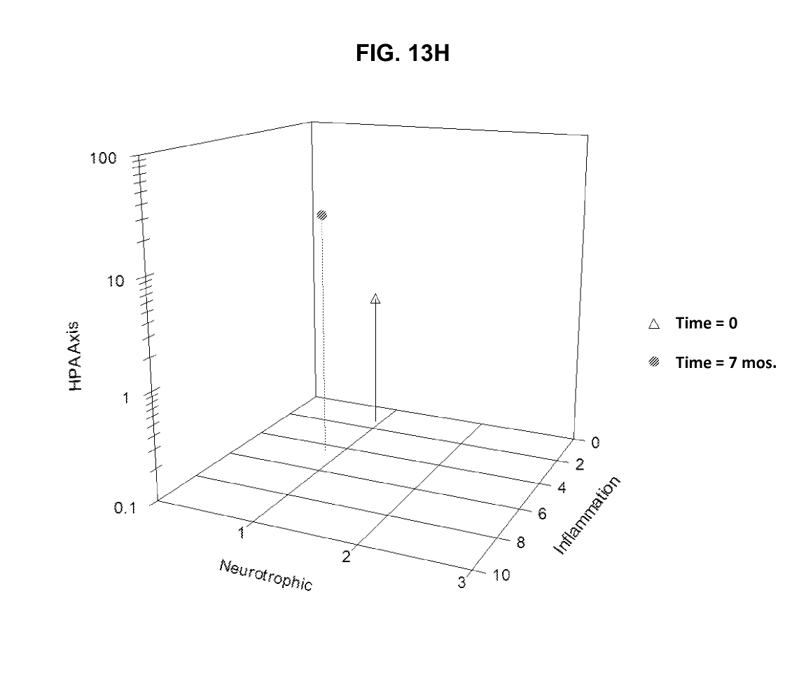

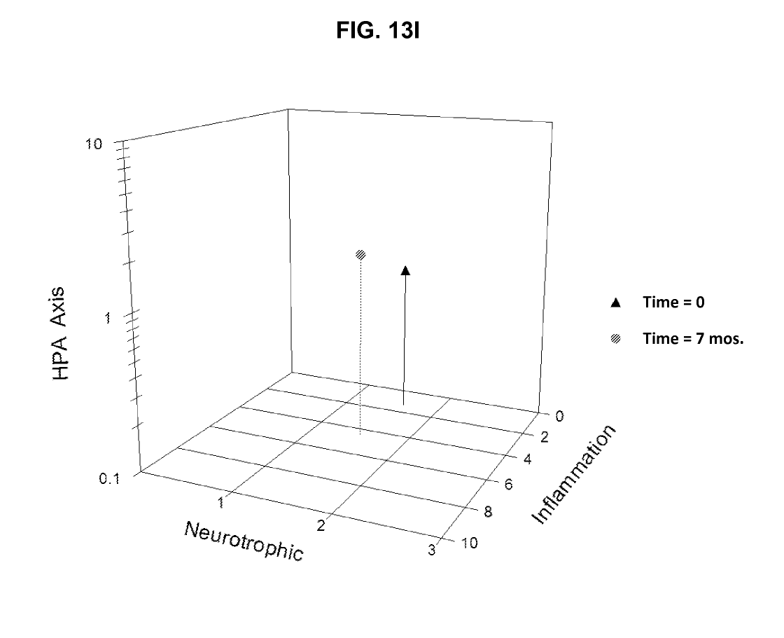

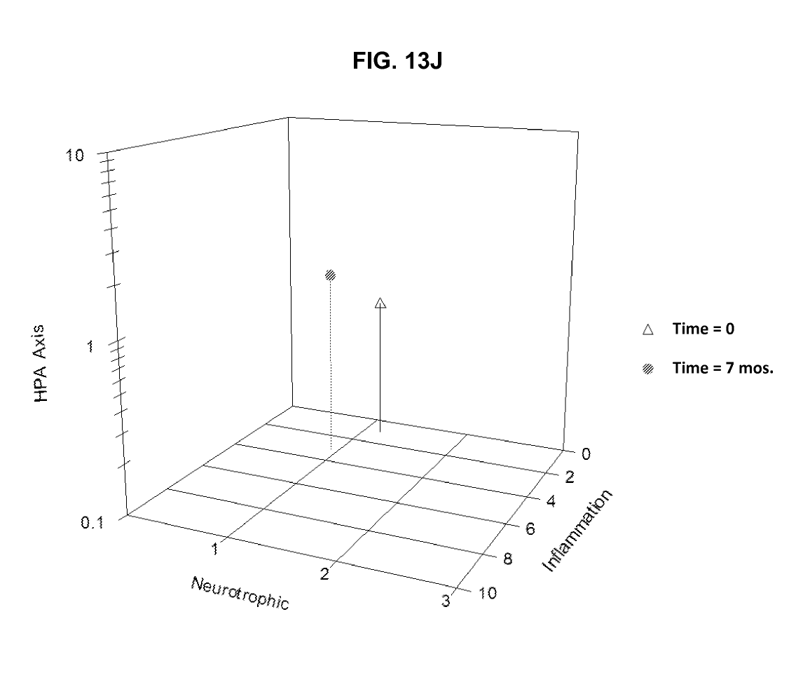

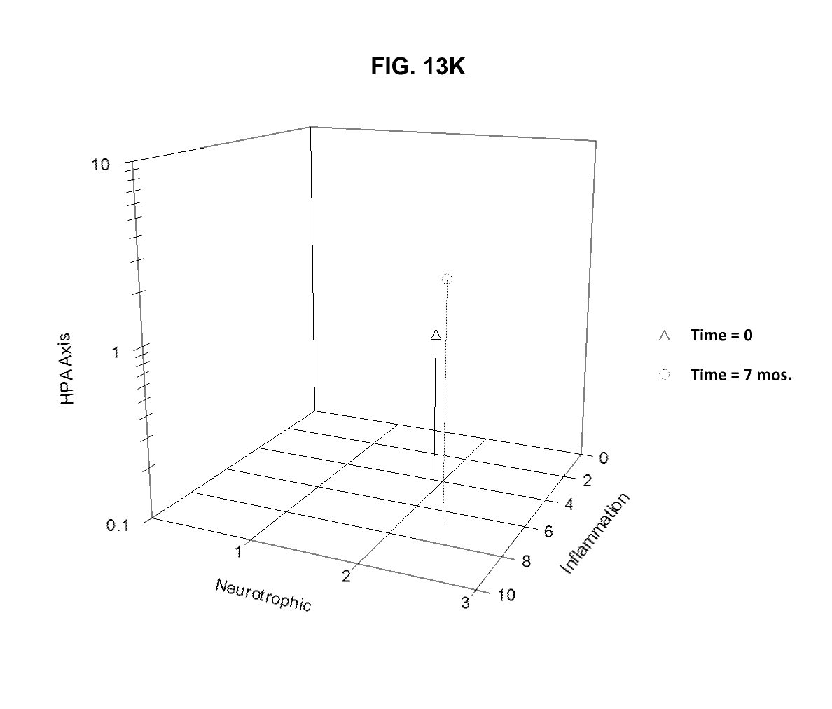

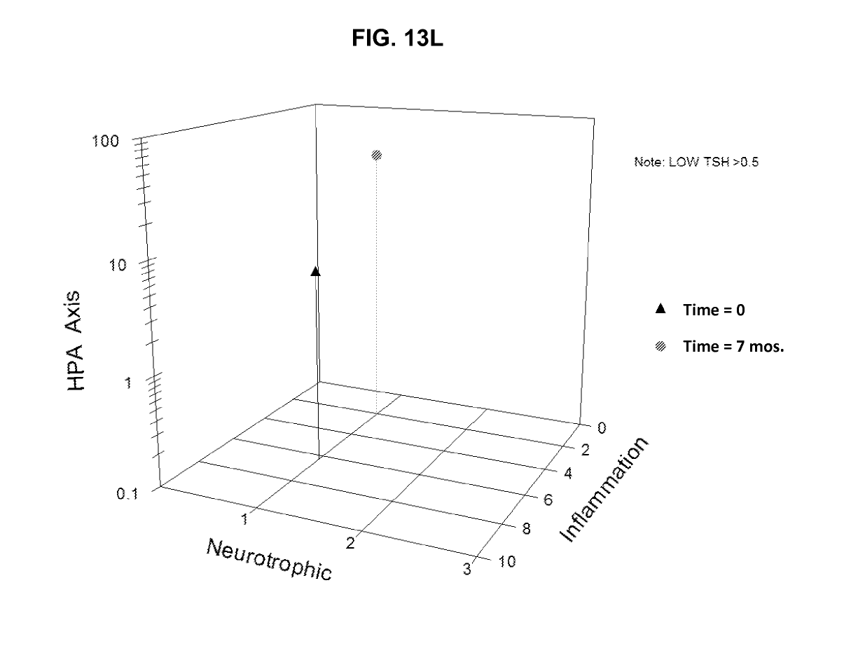

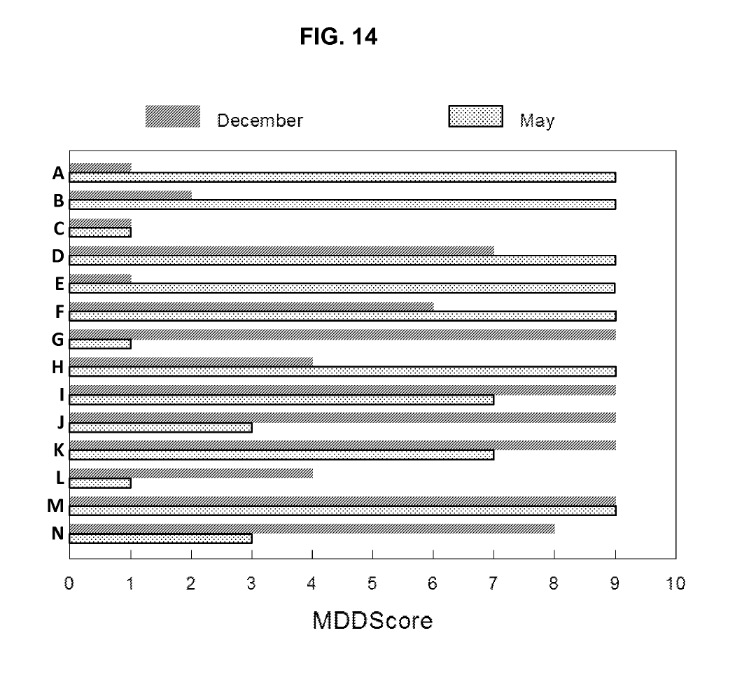

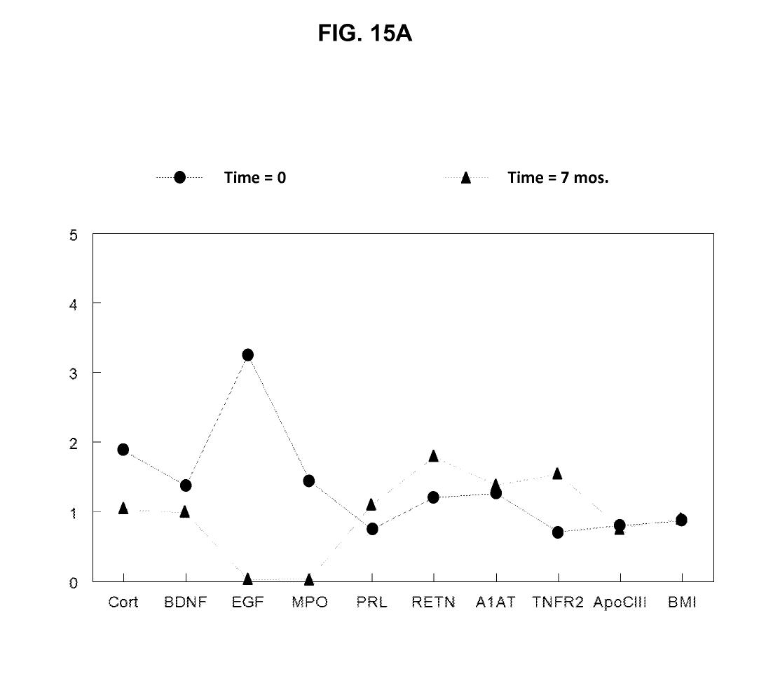

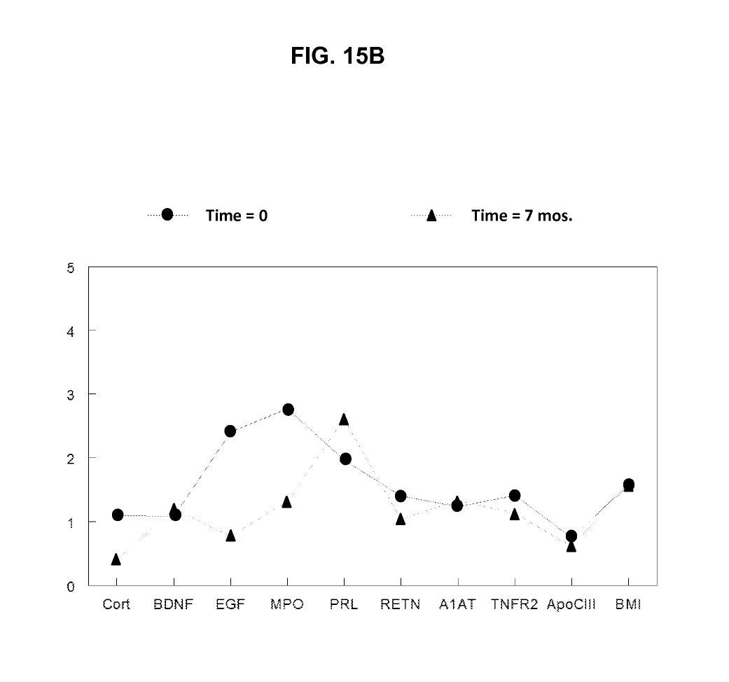

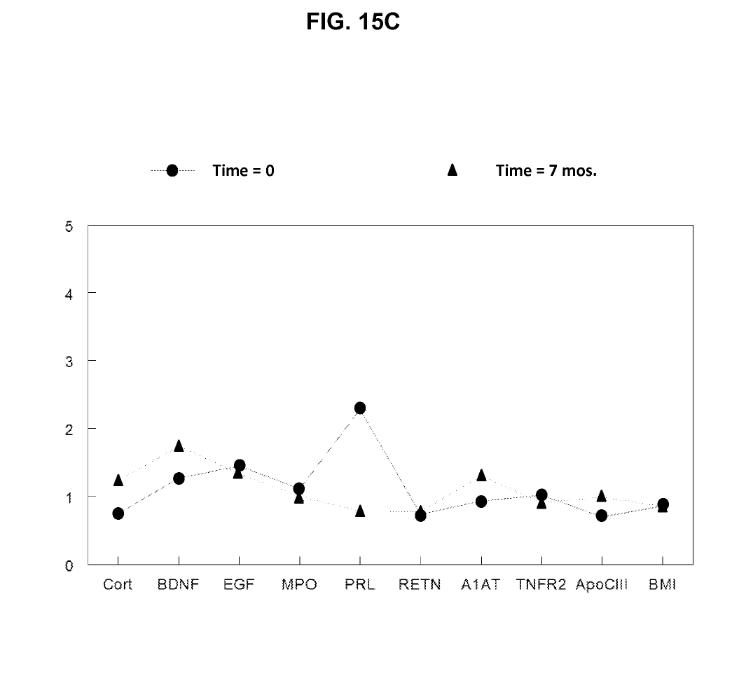

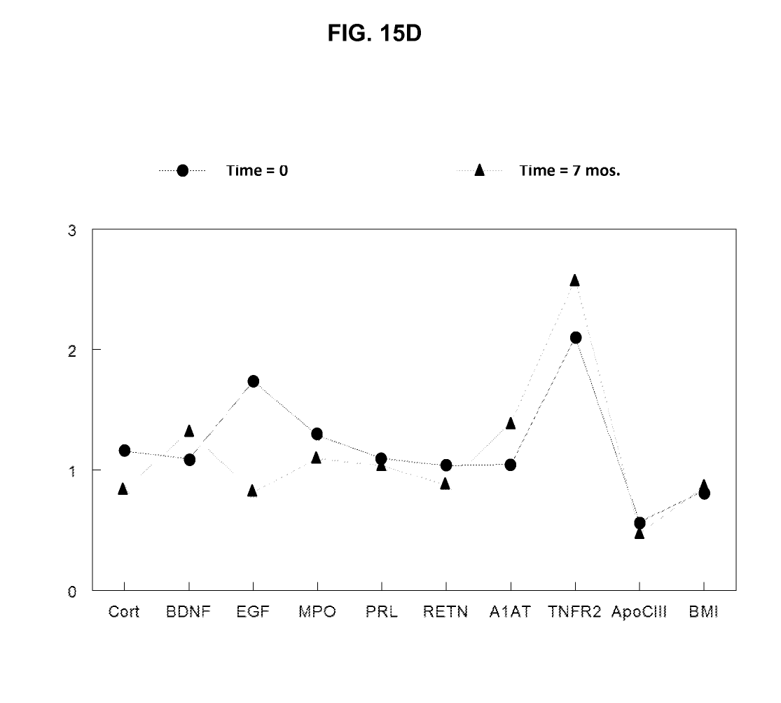

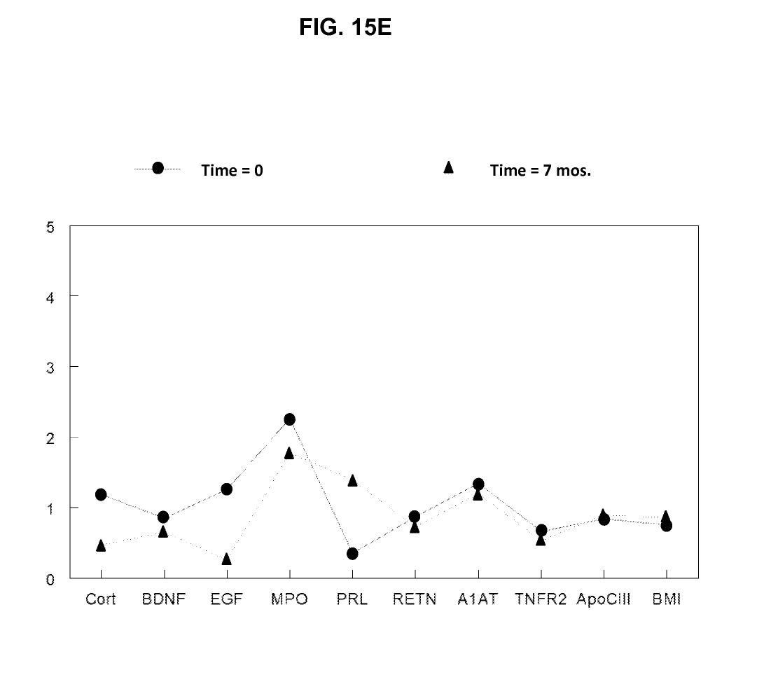

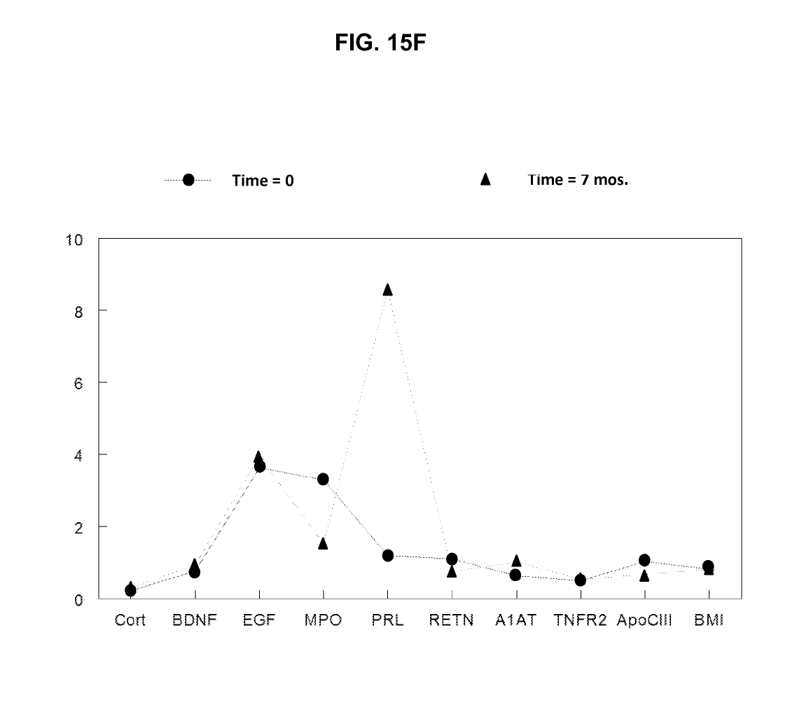

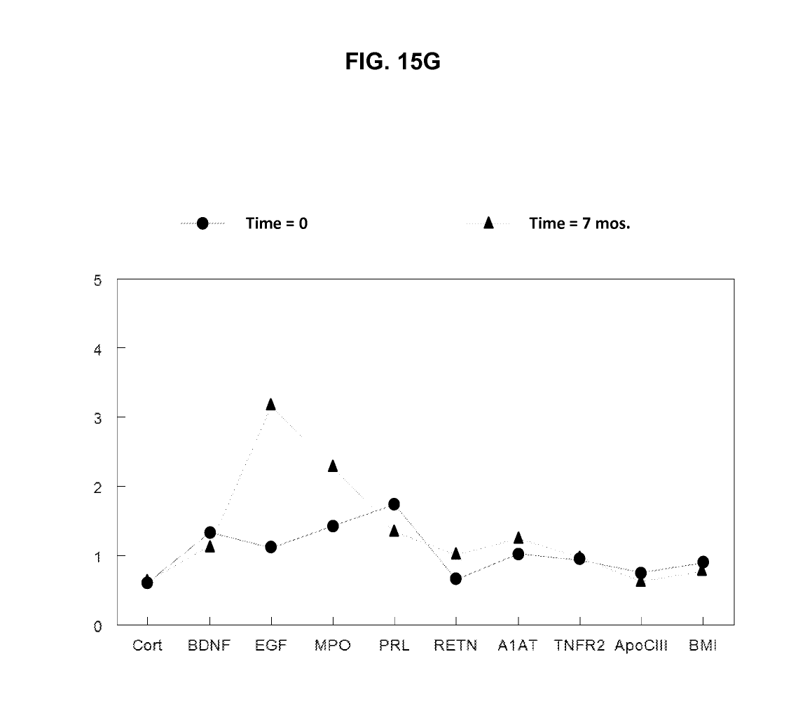

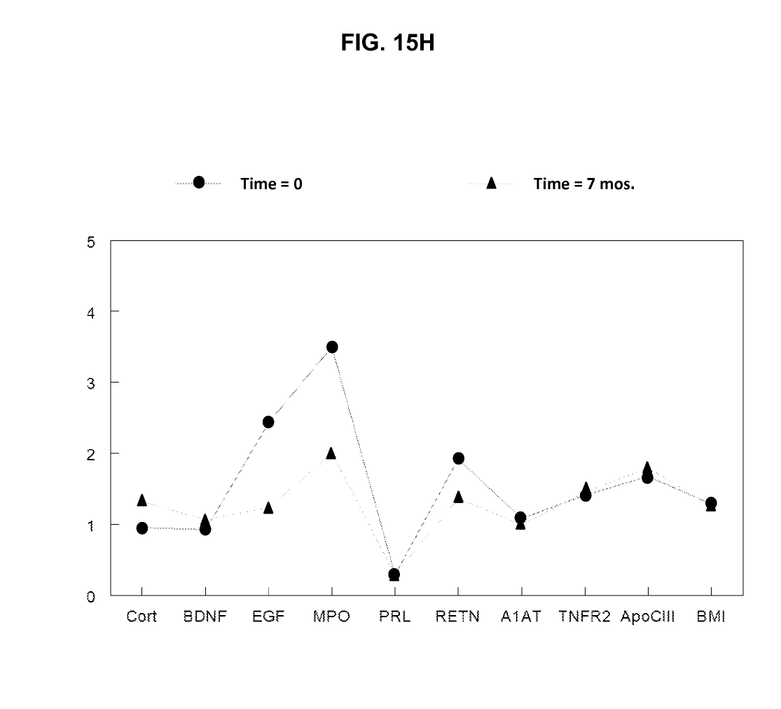

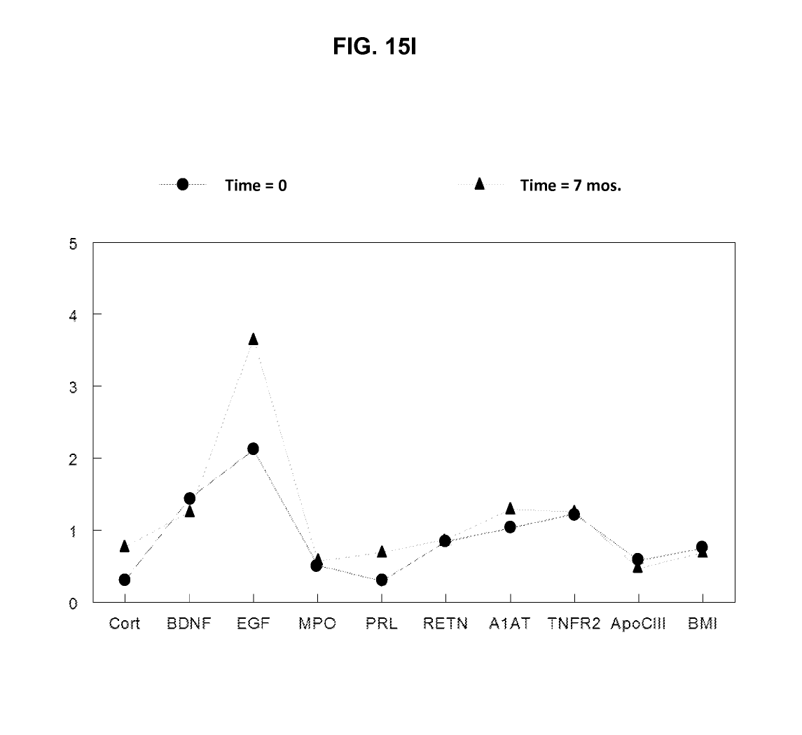

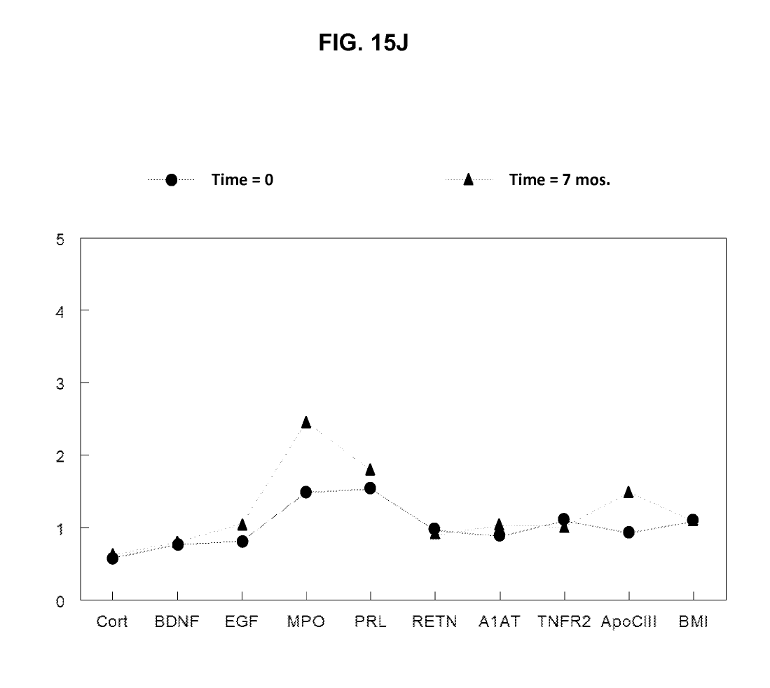

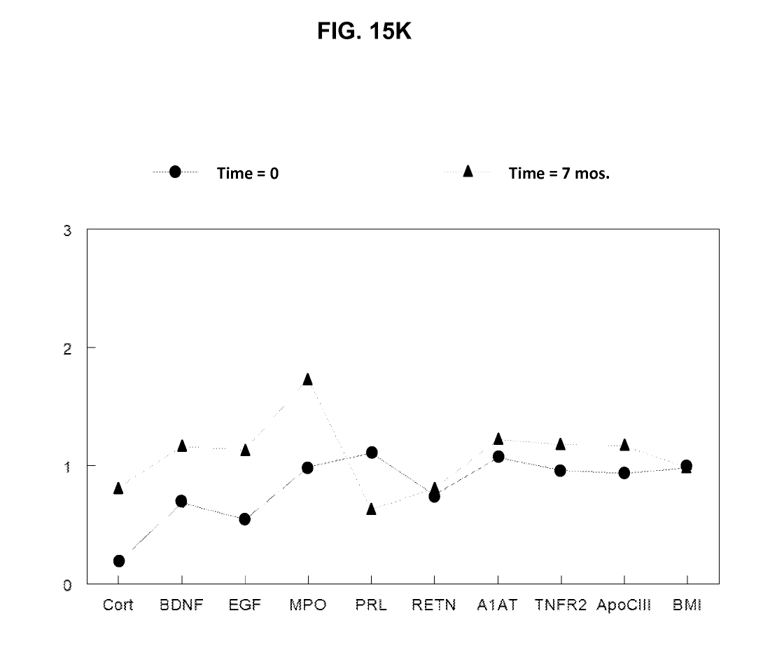

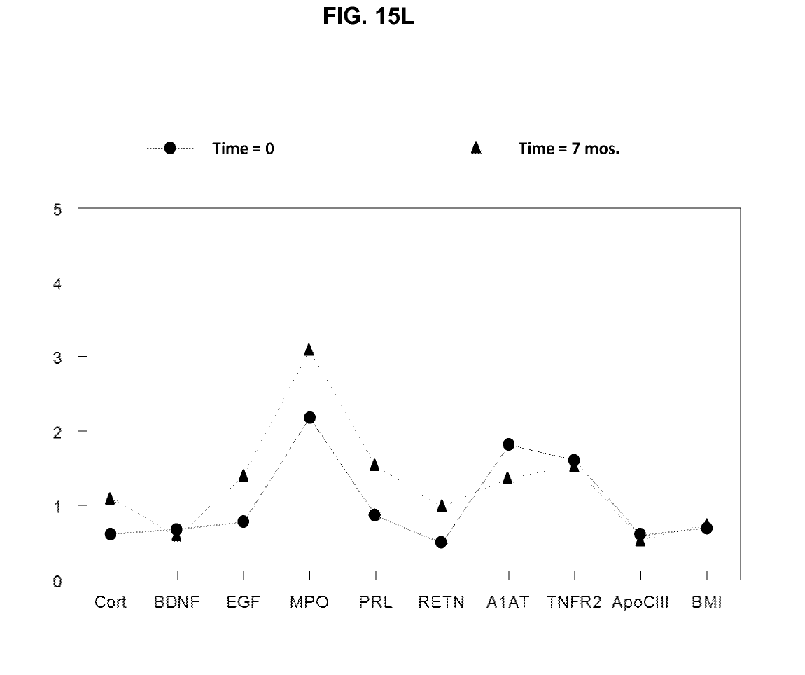

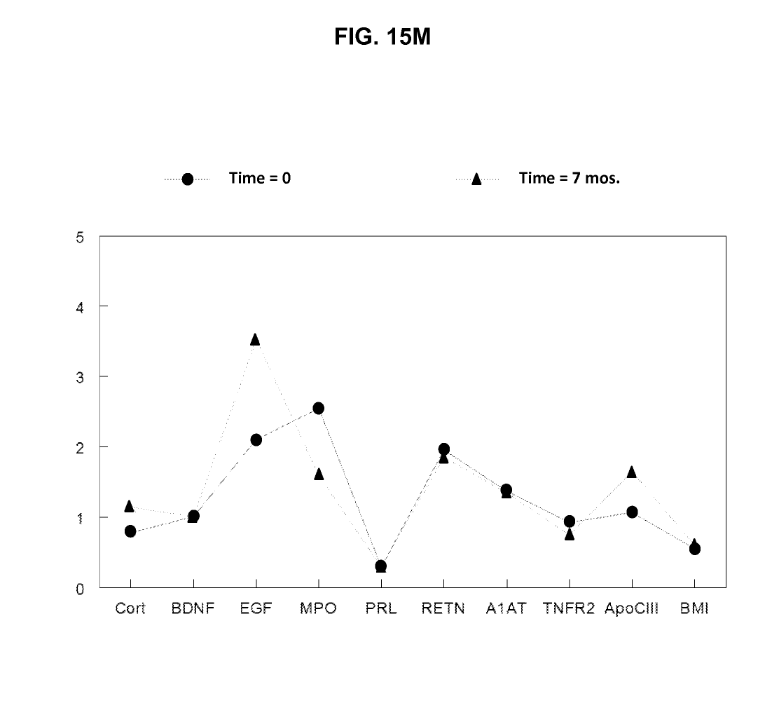

The potential for the use of hypermapping to show changes in marker levels in individual patients post-therapy is illustrated in FIG. 12. The MDDSCORE™ for patient “E” dropped from a 9 to a 1 after eight months of treatment, due at least in part to a 5.9-fold decrease in measured levels of HPA axis markers, and a 1.7-fold decrease in measured levels of inflammatory markers. Hypermaps from 12 additional patients are shown in FIGS. 13A-13L, and a graph summarizing the overall change in MDDSCORE™ for each patient is shown in FIG. 14. TABLE 12 lists the overall change in MDDSCORE™ for each patient, as well as the fold change in measured pathway biomarkers after treatment. Graphs plotting the serum level of each biomarker (cortisol, BDNF, EGF, MPO, PRL, RETN, A1AT, sTNFR2, and ApoCIII) in each CIP patient before and after 8 months of treatment, as well as BMI for each patient before and after treatment, are shown in FIGS. 15A-15M.

To compare data for new patients (e.g., before and after treatment), biomarker concentration data from the MDDSCORE™ panel immunoassays are used. Values are normalized using the medians calculated from the data presented herein (using the same assays, reagents, etc.). The normalization values are used to transform individual patient biomarker data so patient profiles can be compared.

TABLE 12

| Patient | MDDSCORE ™* | HPA markers | Inflammatory markers |
|---|---|---|---|
| A | 9→1 | 115-fold decrease | 8.4-fold decrease |
| B | 9→2 | — | — |
| C | 1→1 | 1.5-fold increase | 1.14-fold decrease |
| D | 9→7 | 1.5-fold decrease | 4-fold decrease |
| E | 9→1 | — | — |
| F | 9→6 | 1.5-fold increase | 4-fold decrease |
| G** | 1→9 | 21-fold increase | 3-fold increase |
| H** | 9→4 | 7.3-fold decrease | 4.7-fold increase |
| I | 7→9 | 8-fold increase | 1.4-fold increase |
| J | 3→9 | 10-fold increase | 3.3-fold increase |
| K | 7→9 | 1.7-fold increase | 3.4-fold increase |
| L | 1→4 | 1.4-fold increase | 3-fold increase |
| M | 9→9 | 3-fold increase | 1.7-fold decrease |
| N | 3→8 | 7-fold increase | 3-fold decrease |

*initial score → post-therapy score
**Note:
Dec LOW TSH >0.5

### Example 3

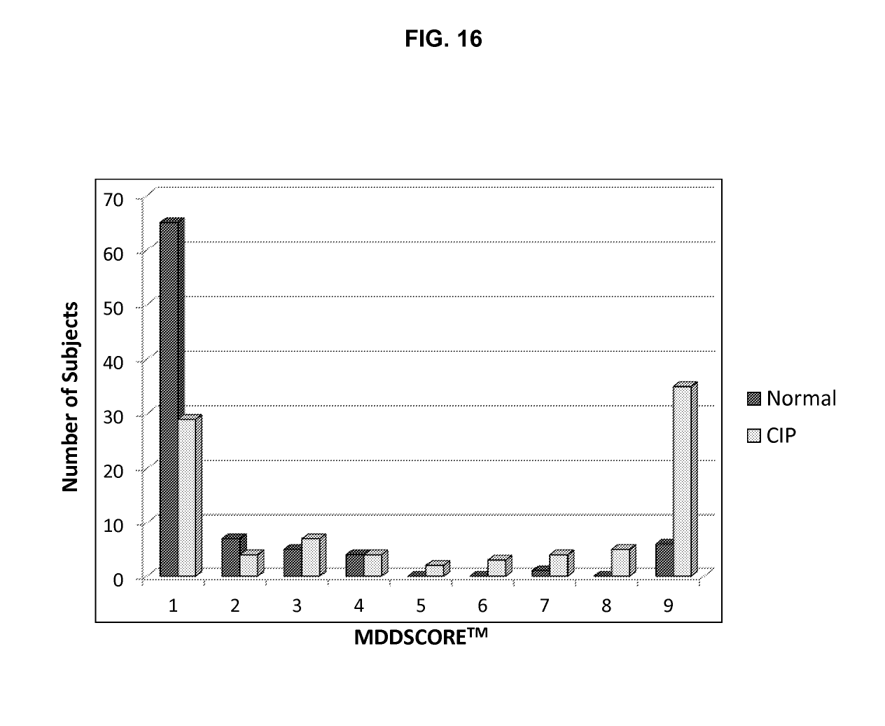

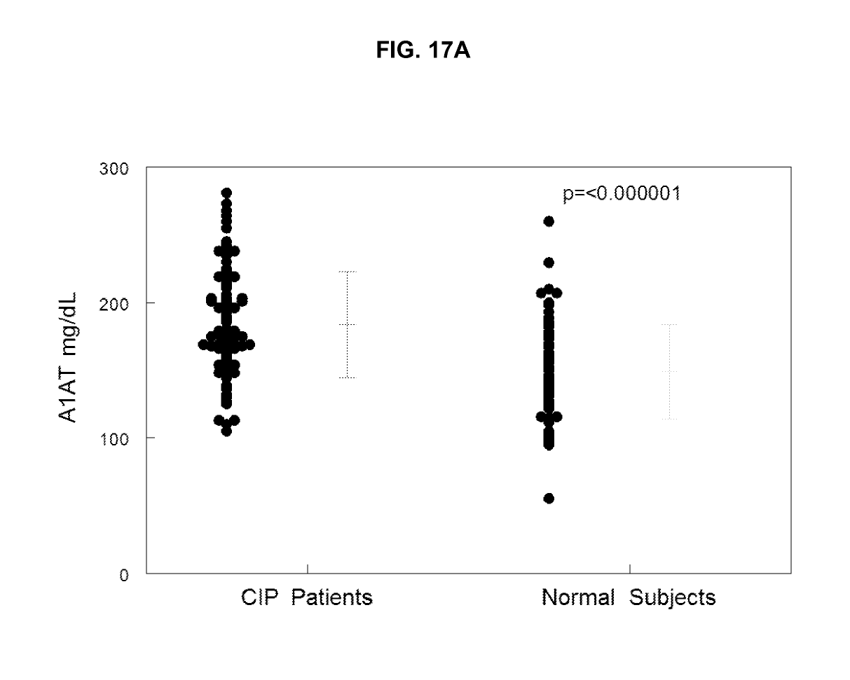

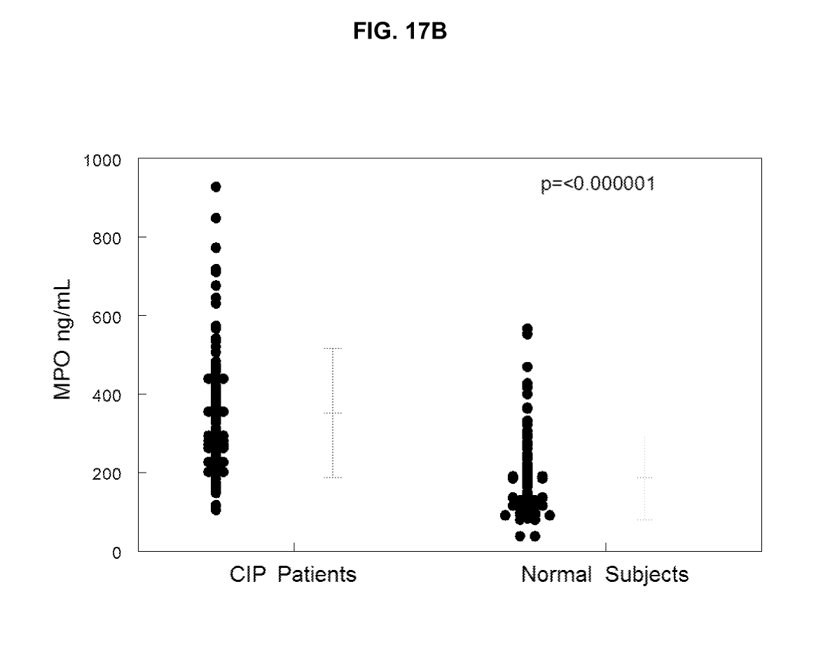

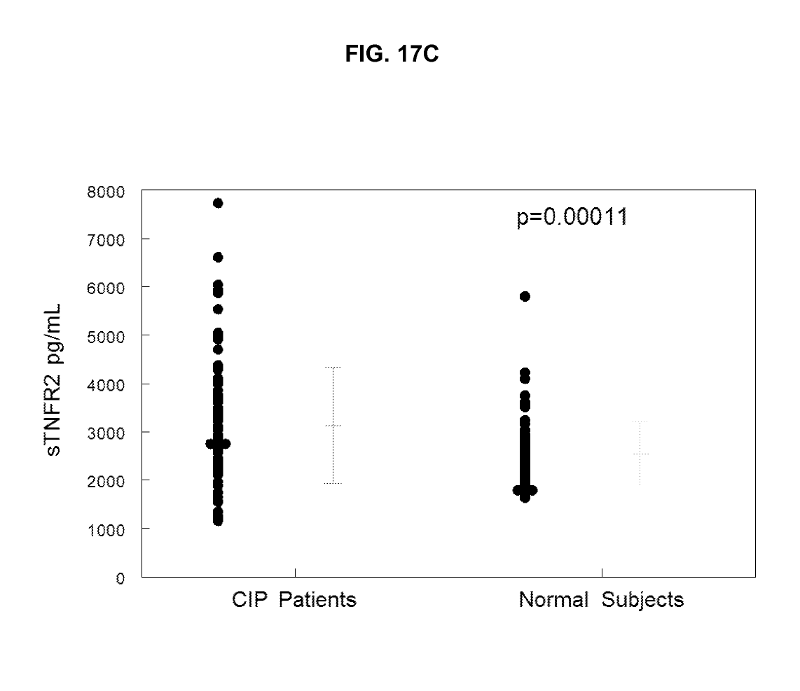

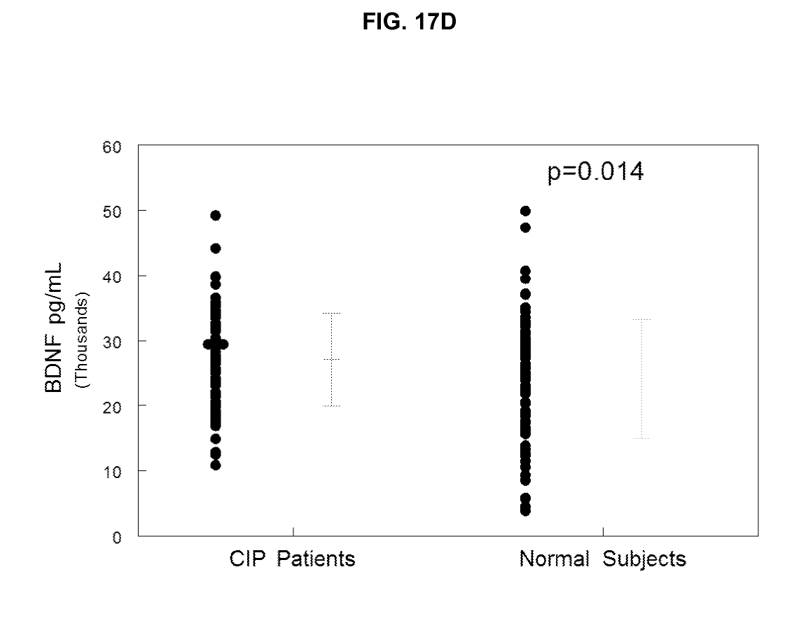

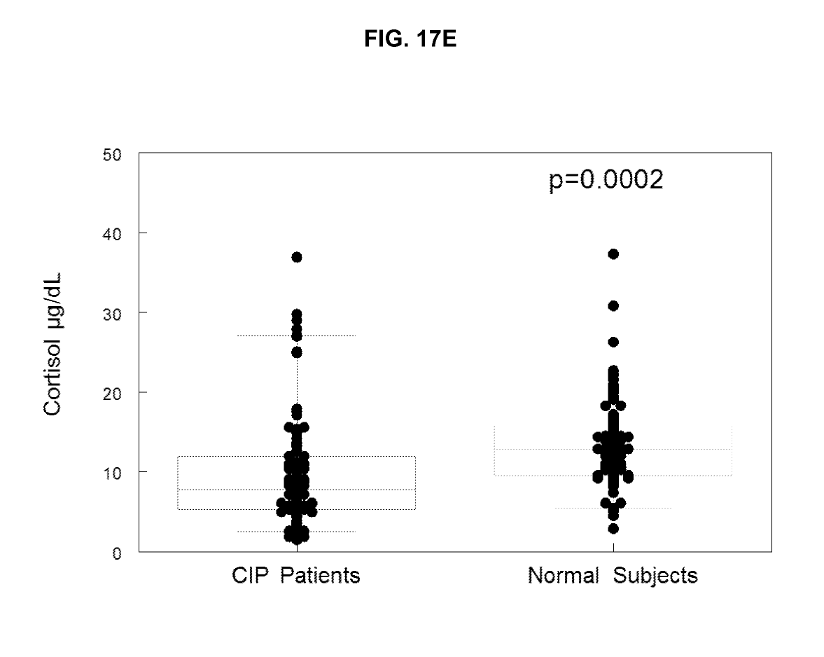

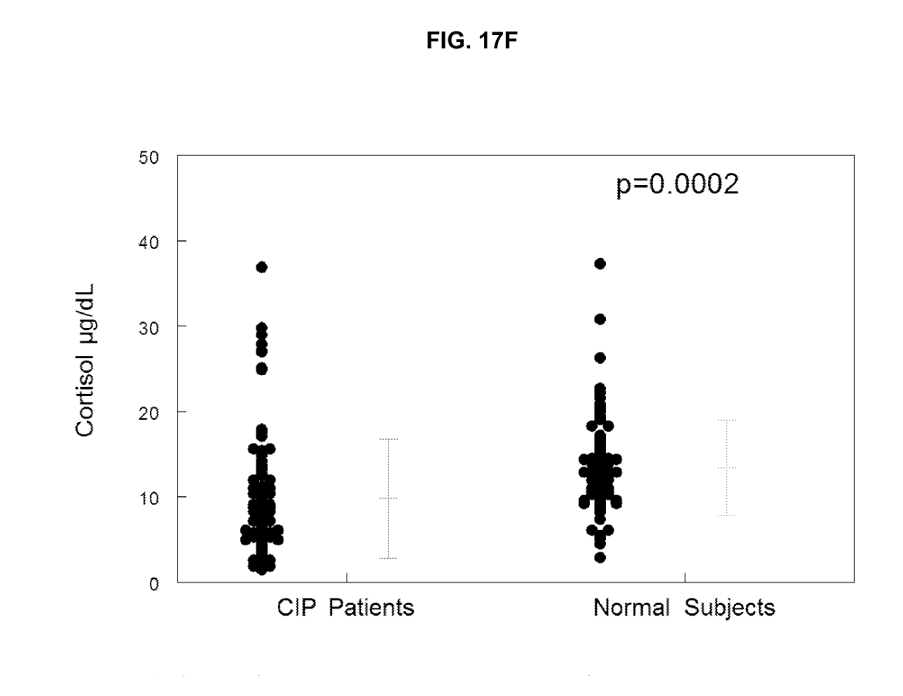

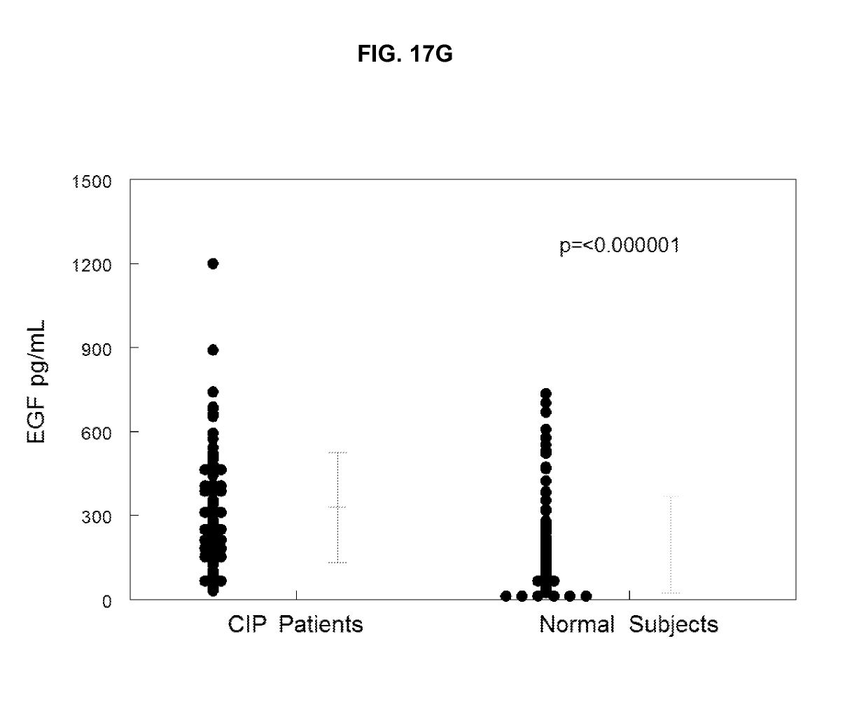

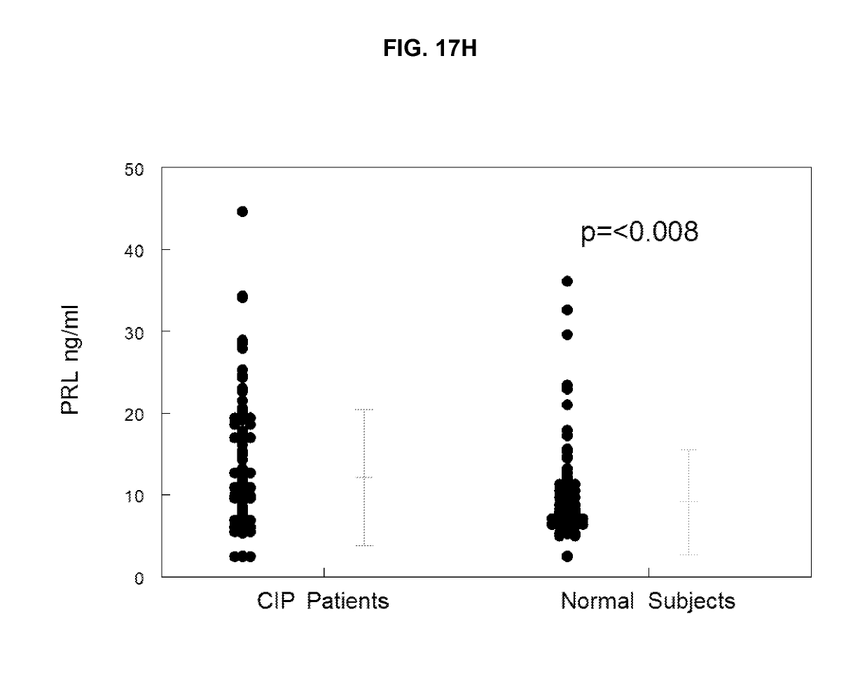

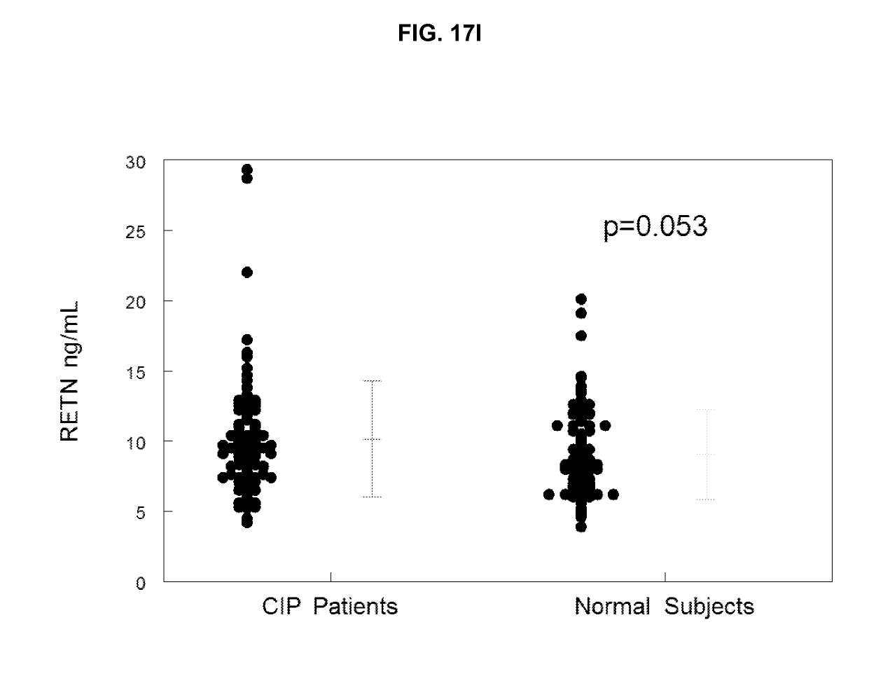

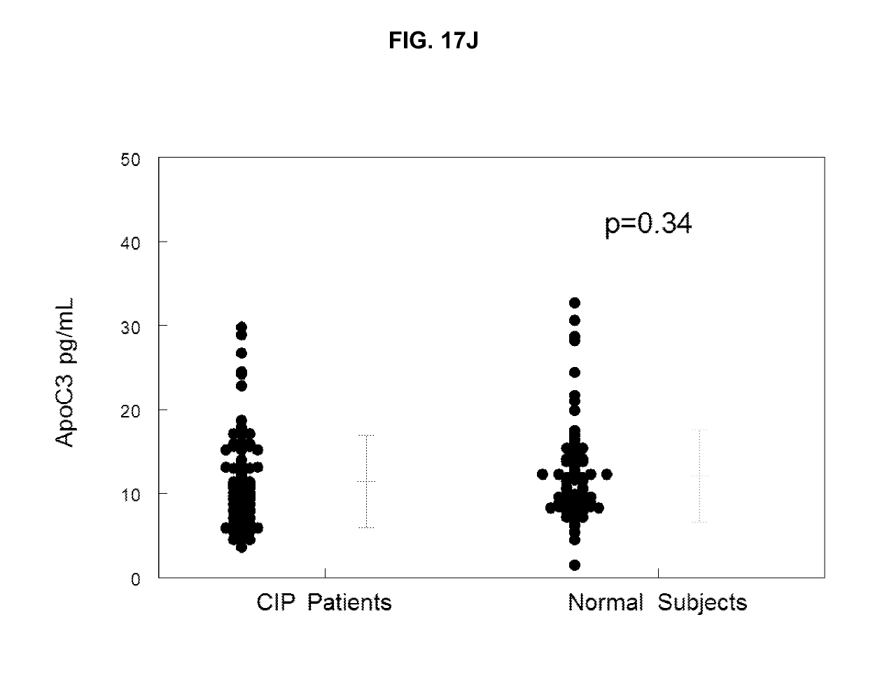

A larger study was conducted to compare the marker panel and MDDSCORE™ in CIP patients (n=94) and in normal, healthy, non-depressed subjects (n=86). FIG. 16 shows a summary of MDDSCORE™s in the study subjects. Both groups displayed MDDSCORE™s ranging from 1 to 9, but the majority of normal subjects had low MDDSCORE™s, while a large portion of the CIP patients had MDDSCORE™s at the upper end of the range. Graphs plotting the levels of individual markers (A1AT, MPO, sTNFR2, BDNF, cortisol, EGF, PRL, RETN, and ApoCIII) in each study subject are shown in FIGS. 17A-17J. Eighteen percent (18%) of CIP patients had A1AT values below the mean of normal subjects; 9.6% of CIP patients had MPO values below the mean of normal subjects; 29% of CIP patients had sTNFR2 values below the mean of normal subjects; 37% of CIP patients had BDNF values below the mean of normal subjects; 77% of CIP patients had cortisol values below the mean of normal subjects; 18% of CIP patients had EGF values below the mean of normal subjects; 34% of CIP patients had PRL values below the mean of normal subjects; 33% of CIP patients had RETN values below the mean of normal subjects; and 59% of CIP patients had ApoC3 values below the mean of normal subjects.

### Example 4

MDDSCORE™ was used in a further study to detect comorbid MDD in patients with CIP. The study group consisted of 94 patients with CIP, with a mean age of 46.6±11.2 (range from 24-72 years). Fifty-nine (˜63%) were female and 35 (˜37%) were male. The average BMI for females was 26.5±7.8 (range from 13.3-48.7). The average BMI for males was 27.9±4.2 (range from 19.6-40.9).

Each patient had a blood sample drawn for measurement of the serum levels of nine biomarkers by immunoassay. The markers were A1AT, ApoC3, BDNF, cortisol (Cort), EGF, MPO, PRL, RETN, and sTNFR2. A proprietary algorithm was used to generate an MDDSCORE™ (range 1-9) using serum biomarker concentrations.

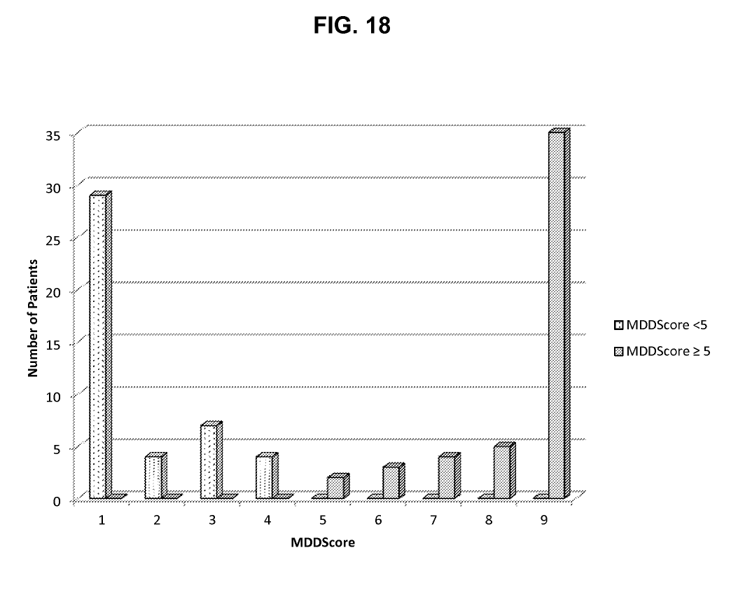

FIG. 18 shows the MDDSCOREs™ obtained for the 94 CIP patients. Fifty-two percent (52%) of the patients had an MDDSCORE™≧5. An MDDSCORE™ between 5 and 9 typically indicates that the patient has about a 90% likelihood of having MDD. Forty-eight percent of the patients had an MDDSCORE™ below 5, which typically indicates about a 95% likelihood of not having MDD.

The patients with an MDDSCORE™≧5 included 34 females and 16 males, while the patients with MDDSCORE™ of less than 5 included 25 females and 19 males. While the males in the two groups were nearly identical with regard to BMI (average BMI 27.5), the females with an MDDSCORE™≧5 had a mean BMI of 28.0±8.4, and their MDDSCORE™<5 comparators had an average BMI of 24.4±8.4 (p=0.07).

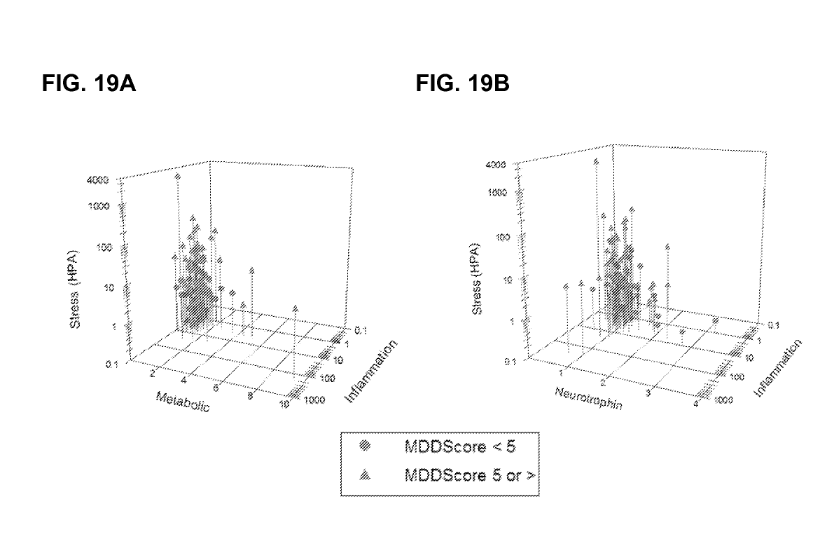

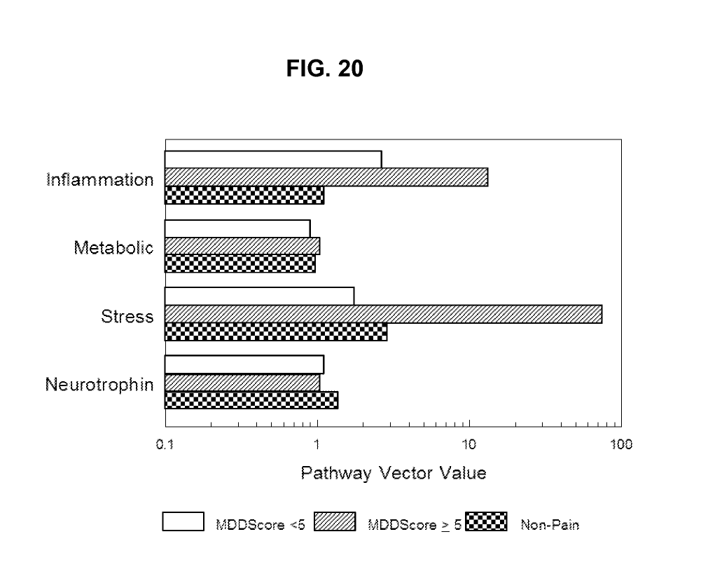

FIGS. 19A and 19B show 3-dimensional hyperspace mapping (hypermaps) of the CIP patients segregated by whether they had a low or high probability of MDD based on the MDDSCORE™ test. In this technique, each patient's values for biomarkers are compared with a previously established population normal value, such that individual differences between patients are revealed (Bilello et al., “Biomarker hypermapping as an aid to the diagnosis, treatment and management of major depressive disorder,” U.S. Psychiatric and Mental Health Congress, November, 2009). Using the hypermapping technique, a vector having direction (the biological pathway) and magnitude (the comparative activation) was generated. The combination of three (3) pathway vectors determines the position of one point in 3-dimensional space relative to another. The comparison between the CIP patients with high vs. low MDDSCORE™ is shown in comparison to a series of healthy subjects without chronic pain. A graph of the pathway vector map is shown in FIG. 20.

### Example 5

Additional studies were conducted to assess the use of MDDSCORE™ in comorbid MDD in patients with CIP. A first objective of these studies was to determine the utility of the MDDSCORE™ test in identifying pain patients with a physiological profile consistent with MDD, and to discriminate them from those who are demoralized by pain and display a depressed mood. A second objective was to assess the serum levels of chronic inflammatory biomarkers within the MDDSCORE™ panel in patients with chronic pain in order to gain insight into and gauge the residual (post-treatment) level of inflammation in chronic pain states.

Methods

The three study groups included: (a) patients with CIP (n=93), (b) patients with chronic pain (SPC; n=20), and (c) a series of prospectively collected patients with comorbid arthritis and depressive symptoms (n=28). The gender and age distribution of the subjects are shown in TABLE 13.

TABLE 13

| Group | Females | Males | Age | Range |
|---|---|---|---|---|
| Arthritis | 19 | 9 | 70.2 ± 11 | 46-89 |
| CIP | 59 | 34 | 47.4 ± 11.3 | 24-72 |
| SPC | 11 | 9 | 50.8 ± 14.1 | 23-76 |

The CIP study group consisted of patients with centralized intractable pain. Fifty-nine (63%) were female and 34 (37%) were male. The average BMI for females was 26.5±7.8 (range 13.3-48.7). Males had an average BMI of 27.9±4.8 (range 19.6-40.9).

The SPC patients were a diverse group, with post-laminectomy syndrome (n=5), fibromyalgia (n=4), degenerative disc disease (n=3), neuralgic headache (n=2), and other chronic pain states (n=6). Eleven patients (55%) were female and 9 (45%) were male. The average BMI for females was 28.5±6.9 (range 20.9-43.3). Males had an average BMI of 27.3±2.8 (range 22.3-28.1).

The arthritis group was a prospective collection of patients with depressed mood whose clinicians listed arthritis as a comorbidity. Nineteen patients (68%) were female and nine (32%) were male. The average BMI for females was 31±5.9 (range 20.2-45.5). Males had an average BMI of 27.3±5.9 (range 18.4-35.5)

Each study subject provided a blood sample, which was processed to collect serum under standardized conditions. Briefly, blood was allowed to clot for 30 minutes, centrifuged 10 minutes at 1300×g (RCF: relative centrifugal force) to collect serum that was aliquoted within 30 minutes of centrifugation, frozen at minus 80° C. until ready for shipment on dry ice to the Ridge Diagnostics CLIA Laboratory (Research Triangle Park, N.C.). The date and time of the blood draw was recorded by the study site for each sample.

Serum levels of the nine biomarkers in the MDDSCORE™ panel (A1AT, ApoCIII, BDNF, cortisol, EGF, MPO, PRL, RETN, and sTNFRII, were measured by individual quantitative immunoassays. Standard curves for calibrating the quantity of each biomarker were generated by serial dilution of each purified protein. The range of the standards for each assay was based upon the Ridge CLIA laboratory's analysis of multiple samples to establish the standard distribution surrounding the concentrations found in the serum of male and female subjects. Gender specific differences were observed for some analytes. Both A1AT and ApoCIII concentration were measured by an analytically validated turbidimetric assay (developed at the Ridge Laboratory). BDNF, sTNFRII, and EGF levels were determined using Quantikine human ELISA kits from R&D Systems (Minneapolis, Minn.). MPO was measured by a human serum ELISA kit obtained from ALPCO Immunoassays (Salem, N.H.). PRL in serum was measured using a human serum ELISA, and cortisol levels in serum were determined using a competition ELISA, both of which were obtained from Monobind (Lake Forest, Calif.). These methods of detection were improvements over those used in earlier studies.

Reference ranges for the individual biomarkers were determined from a set of 105 control sera from individuals not known to be depressed and obtained from a commercial source (BioReliance, Rockville, Md.). The mean, standard deviation (SD) and ±2 SD limits were calculated for each biomarker.

The sensitivity and specificity of the MDDSCORE™ panel and algorithm are 94 and 92%, respectively, and the area under the ROC curve (AUC) is 0.96 (Bilello et al. 2015, supra).

Serum cortisol levels undergo diurnal variation, with peak levels occurring between 6-8 A.M. that gradually fall over the course of the day, reaching a low point around midnight. While the majority of subjects had their blood drawn for MDDSCORE™ testing in the late morning or early afternoon, when the decline in cortisol was linear, patients drawn early in the day (particularly 30-45 minutes after awakening) had peak levels. To control for this variation, a method was developed to convert all cortisol values to a noon-time equivalent using a concentration time curve derived from studies of diurnal variation in normal subjects and MDD patients (Ansari, Harvard Rev Psych 7(5):257-277, 2000; and Turk et al., Lancet 377(9784):2226-2235, 2011).

Age, gender, height, and weight of each subject was recorded, and BMI was calculated using the formula BMI=(weight in lbs.×703)/(height in inches)² and an online calculator (mayoclinic.com/health/bmi-calculator/NU00597). The MDDSCORE™ algorithm has been described elsewhere (Bilello et al. 2015, supra).

The full algorithmic model is:

Dx˜Gender+CORT2+BDNF+log(MPO)+log(EGF)+Gender*(PRL+RETN+sTNFRII+BMI)+A1AT+APOC3,

where X*Y directs the model to include an interaction term between the variables X and Y as well as those variables themselves, and X*(Y+Z) is shorthand for X*Y+X*Z.

P values were calculated in Excel using the TTEST function and assuming two tails and two samples of equal variance (homoscedastic).

Results

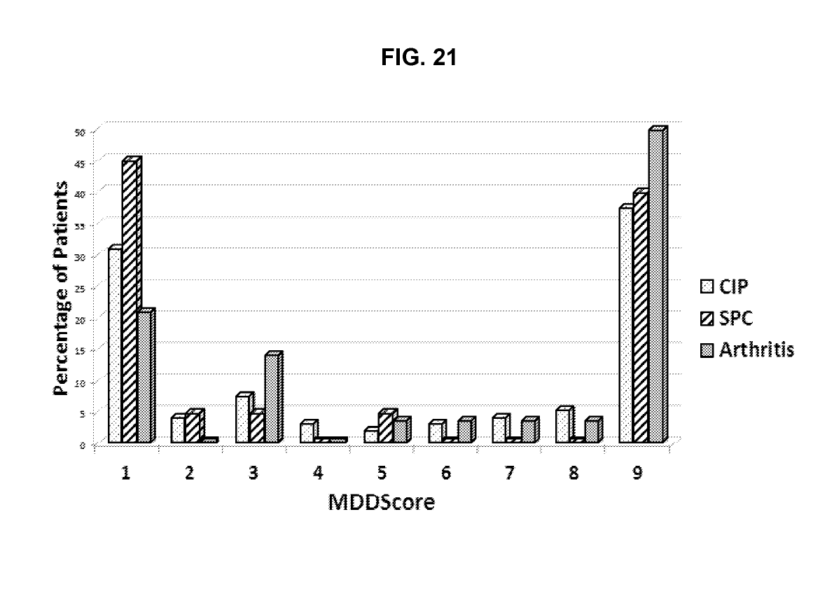

The MDDSCORE™ utilizes the resultant serum concentrations of all of the biomarkers on the MDDSCORE™ panel in an algorithm that provides a single score between 1 and 9 (Smith et al., Comprehensive Psych, 54(1):1-6, 2013). FIG. 21 shows the distribution of MDDSCORE™ in each of the three patient populations. The distribution of scores was not Gaussian. Rather, a very distinct bi-modal pattern was observed. Overall, 43.5% scored 1-3, 8% scored 3-6, and 48.5% scored 7-9. Eighteen of 28 patients with comorbid arthritis (64.2%) had an MDDSCORE™ greater or equal to 5. Forty-nine of 93 CIP patients (52.7%), 18 of 28 arthritis patients (64.2%), and 9 of 20 patients with chronic pain of diverse origin (45%) had scores of ≧5. This is in contrast to a prospective study using the same algorithm and assay technology, in which 93.7% of well characterized MDD patients had an MDDSCORE™ greater or equal to 5 and 91.8% of control patients had scores of <5 (Bilello et al. 2015, supra). As shown in FIG. 21, the majority of the patients with chronic pain had an MDDSCORE™ of 1 or 9, indicating that patients with chronic pain exhibit a bimodal pattern.

Since the MDDSCORE™ algorithm incorporates gender and BMI as clinical parameters, the distribution of MDDSCORE™ by gender and BMI also were assessed. TABLE 14 shows the distribution of MDDSCORE™<5 and ≧5 in the pain populations, by gender.

TABLE 14

| | |
|---|---|
| Males (%) | Females (%) |

| Group | <5 | ≧5 | <5 | ≧5 |
|---|---|---|---|---|
| Arthritis | 31.6 | 68.4 | 44.4 | 55.6 |
| CIP | 54.5 | 44.5 | 42.4 | 57.6 |
| SPC | 44.4 | 55.6 | 63.6 | 37.4 |

TABLE 14 shows the percentage of male and female pain patients with an MDDSCORE™ of <5 or ≧5. While there were differences in the absolute distribution, there was no significant bias of MDDSCORE™ in male and female patients.

Further, no significant differences in BMI were observed between female patients with an MDDSCORE™<5 (26.6±7.2) and those with an MDDSCORE™≧5 (28.6±7.7; p=0.21). Similarly, there were no significant differences in BMI in male pain patients with an MDDSCORE™<5 (27.1±4.4) and those with an MDDSCORE™≧5 (27.8±4.4; p=0.53).

The MDDSCORE™ test panel measures the serum concentrations of biomarkers that include three markers of chronic inflammation: A1AT, MPO and sTNFR2. TABLES 15-16 show the mean serum concentrations of each chronic inflammatory biomarker for the pain patients. The chronic pain patient data is presented along with that of MDD patients and non-depressed controls from an earlier study described elsewhere (Bilello 2015, supra).

TABLE 15
Serum Concentrations of Alpha-1-Antitrypsin (mg/dL)

| Group | n | Mean | Std Dev | Range |
|---|---|---|---|---|
| Arthritis | 28 | 138.7 | 28.8 | 74-201 |
| CIP | 93 | 183 | 38.9 | 105-281 |
| SPC | 20 | 130.2 | 42.1 | 71-215 |
| Non-Depressed | 86 | 148.9 | 35.2 | 55.259 |
| MDD Patients | 68 | 156.0 | 37.3 | 92-257 |

TABLE 16
Serum Concentration of Myeloperoxidase (ng/mL)

| Group | n | Mean | Std Dev | Range |
|---|---|---|---|---|
| Arthritis | 28 | 192.5 | 101.3 | 88-539 |
| CIP | 93 | 352.4 | 164.9 | 105-928 |
| SPC | 20 | 238.3 | 119.0 | 102-488 |
| Non-Depressed | 86 | 188.2 | 107.9 | 80-567 |
| MDD Patients | 68 | 273.5 | 178.7 | 89-925 |

TABLE 17
Serum Concentrations of soluble Tumor
Necrosis Factor Receptor Type 2 (pg/mL)

| Group | n | Mean | Std Dev | Range |
|---|---|---|---|---|
| Arthritis | 28 | 4861.5 | 2537.7 | 2167-13654 |
| CIP | 93 | 3078.9 | 1109.4 | 1154-7727 |
| SPC | 20 | 2559.2 | 947.2 | 1479-4614 |
| Non-Depressed | 86 | 2548.1 | 666.7 | 1633-5798 |
| MDD Patients | 68 | 2550.7 | 681.9 | 1428-4810 |

It is clear from TABLES 15-17 that there were differences in the scrum concentration of A1AT, MPO and STNFR2 between groups of subjects. The CIP patients had the highest serum levels of A1AT and MPO, while patients with arthritis had the highest concentrations of circulating sTNFR2, Probability (p values) were calculated using Student's T test to assess the statistical significance of differences in serum concentration of each biomarker between the chronic pain populations, healthy non-depressed subjects and well characterized MDD patients. TABLES 18-20 indicate the p values for A1AT, MPO, and sTNFR2 between the chronic pain groups, the normal subjects, and the MDD patients from the earlier study (Bilello 2015, supra). CIP patients were significantly different from all other groups of patients.

TABLE 18
P values for Serum Concentrations
of A1AT between Study Groups

| | Arthritis | SPC | CIP | Normal | MDD |
|---|---|---|---|---|---|
| Arthritis | — | 0.39 | <0.0001 | 0.16 | 0.03 |
| SPC | 0.39 | — | <0.0001 | 0.036 | 0.01 |
| CIP | <0.0001 | <0.0001 | — | 0.0001 | <0.0001 |
| Normal | 0.16 | 0.036 | <0.0001 | — | 0.23 |
| MDD | 0.03 | 0.01 | <0.0001 | 0.23 | — |

TABLE 19
P values for Serum Concentrations of MPO between Study Groups

| | Arthritis | SPC | CIP | Normal | MDD |
|---|---|---|---|---|---|
| Arthritis | — | 0.158 | <0.0001 | 0.854 | 0.027 |
| SPC | 0.158 | — | 0.004 | 0.069 | 0.409 |
| CIP | <0.0001 | 0.004 | — | <0.0001 | 0.004 |
| Normal | 0.854 | 0.069 | <0.0001 | — | 0.0003 |
| MDD | 0.027 | 0.409 | 0.004 | 0.0003 | — |

TABLE 20
P values for Serum Concentrations
of sTNFR2 between Study Groups

| | Arthritis | SPC | CIP | Normal | MDD |
|---|---|---|---|---|---|
| Arthritis | — | 0.0005 | <0.0001 | <0.0001 | <0.0001 |
| SPC | 0.0005 | — | 0.05 | 0.95 | 0.96 |
| CIP | <0.0001 | 0.05 | — | 0.0001 | 0.0005 |
| Normal | <0.0001 | 0.95 | 0.0001 | — | 0.98 |
| MDD | <0.0001 | 0.96 | 0.0005 | 0.98 | — |

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A method for treating depression in a subject diagnosed as having centralized intractable pain (CIP), comprising:
(a) performing a quantitative assay to measure the level of each of at least three biomarkers in a biological sample from the subject, to obtain a numerical value corresponding to the measured level of each biomarker, wherein the at least three biomarkers are selected from the group consisting of cortisol, prolactin (PRL), epidermal growth factor (EGF), myeloperoxidase (MPO), brain-derived neurotrophic factor (BDNF), resistin (RETN), soluble tumor necrosis factor alpha receptor type 2 (sTNFR2), apolipoprotein CIII (ApoC3), and alpha 1 antitrypsin (A1AT);
(b) calculating a depression diagnostic score using an algorithm that weights each numerical value;
(c) comparing the calculated depression diagnostic score to a control score calculated using the algorithm and numerical values corresponding to measured levels of the at least three biomarkers in normal subjects;
(d) diagnosing the subject as having depression when the difference between the diagnostic depression score and the control score is greater than a predetermined threshold; and
(e) treating the subject for depression.

2. The method of claim 1, comprising performing the quantitative assay to measure the level of each of at least five biomarkers in the biological sample, to obtain a numerical value corresponding to the measured level of each biomarker, wherein the at least five biomarkers are selected from the group consisting of cortisol, PRL, EGF, MPO, BDNF, RETN, sTNFR2, ApoC3, and A1AT.

3. The method of claim 1, comprising performing the quantitative assay to measure the level of each of at least seven biomarkers in the biological sample, to obtain a numerical value corresponding to the measured level of each biomarker, wherein the at least seven biomarkers are selected from the group consisting of cortisol, PRL, EGF, MPO, BDNF, RETN, sTNFR2, ApoC3, and A1AT.

4. The method of claim 1, wherein the at least three biomarkers comprise cortisol, PRL, EGF, MPO, BDNF, RETN, sTNFR2, ApoC3, and A1AT.

5. The method of claim 1, wherein the biomarkers further comprise body mass index (BMI).

6. The method of claim 1, wherein the biological sample is a blood or urine sample.

7. The method of claim 6, wherein the blood sample is a serum sample.

8. (canceled)

9. The method of claim 1, wherein the comparing step comprises using a hypermap to assess the difference between the diagnostic depression score and the control score.

10. (canceled)

11. (canceled)

12. A method for treating CIP, comprising:
(a) performing a quantitative assay to measure the level of each of three or more biomarkers in a biological sample from a subject suspected to have CIP, to obtain a numerical value corresponding to the measured level of each biomarker, wherein the three or more biomarkers are selected from the group consisting of cortisol, PRL, EGF, MPO, BDNF, RETN, sTNFR2, ApoC3, and A1AT;
(b) calculating a CIP diagnostic score using an algorithm that weights each numerical value;
(c) comparing the calculated CIP diagnostic score to a control score calculated using the algorithm and numerical values corresponding to measured levels of the at least three biomarkers in normal subjects;
(d) diagnosing the subject as having CIP when the difference between the CIP diagnostic score and the control score is greater than a predetermined threshold; and
(e) treating the subject for CIP.

13. The method of claim 12, comprising performing the quantitative assay to measure the level of each of at least five biomarkers in the biological sample, to obtain a numerical value corresponding to the measured level of each biomarker, wherein the at least five biomarkers are selected from the group consisting of cortisol, PRL, EGF, MPO, BDNF, RETN, sTNFR2, ApoC3, and A1AT.

14. The method of claim 12, comprising performing the quantitative assay to measure the level of each of at least seven biomarkers in the biological sample, to obtain a numerical value corresponding to the measured level of each biomarker, wherein the at least seven biomarkers are selected from the group consisting of cortisol, PRL, EGF, MPO, BDNF, RETN, sTNFR2, ApoC3, and A1AT.

15. The method of claim 12, wherein the at least three biomarkers comprise cortisol, PRL, EGF, MPO, BDNF, RETN, sTNFR2, ApoC3, and A1AT.

16. The method of claim 12, wherein the biomarkers further comprise BMI.

17. The method of claim 12, wherein the biological sample is a blood or urine sample.

18. The method of claim 17, wherein the blood sample is a serum sample.

19. The method of claim 12, wherein the quantitative assay is an immunological assay.

20. The method of claim 12, wherein the comparing step comprises using a hypermap to assess the difference between the CIP diagnostic score and the control score.

21. The method of claim 12, further comprising performing a quantitative assay to measure the level of an opioid compound in a second biological sample from the subject.

22. (canceled)

23. A method for treating pain and depression, comprising:
(a) identifying a subject being treated for pain;
(b) testing the subject for depression;
(c) if the subject is identified as having depression, treating the depression, or if the subject is identified as not having depression, repeating step (b) after a period of time; and
(d) maintaining the treatment for pain.

24. The method of claim 23, wherein step (b) comprises:
(i) performing a quantitative assay to measure the level of each of at least three biomarkers in a biological sample from the subject, to obtain a numerical value corresponding to the measured level of each biomarker, wherein the at least three biomarkers are selected from the group consisting of cortisol, PRL, EGF, MPO, BDNF, RETN, sTNFR2, ApoC3, and A1AT,
(ii) calculating a depression diagnostic score using an algorithm that weights each numerical value;
(iii) comparing the calculated depression diagnostic score to a control score calculated using the algorithm and numerical values corresponding to measured levels of the at least three biomarkers in normal subjects; and
(iv) identifying the subject as having depression when the difference between the diagnostic depression score and the control score is greater than a predetermined threshold.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)
